(19) United States
(12) Patent Application Publication
(10) Pub. No.: US 2013/0191299 A1
(43) Pub. Date: Jul. 25, 2013

(54) METHODS AND APPARATUS FOR A SOCIAL RECRUITING NETWORK

(71) Applicant: TALENTCIRCLES, INC., San Francisco, CA (US)

(72) Inventors: Dominique HERMSDORFF, Los Gatos, CA (US); Geoffrey LEE, San Mateo, CA (US); Yuriy MIKHALEVSKIY, San Francisco, CA (US); Marylene DELBOURG-DELPHIS, Menlo Park, CA (US)

(73) Assignee: TALENTCIRCLES, INC., San Francisco, CA (US)

(21) Appl. No.: 13/761,860

(22) Filed: Feb. 7, 2013

Related U.S. Application Data
(63) Continuation-in-part of application No. 12/914,260, filed on Oct. 28, 2010.
(60) Provisional application No. 61/596,058, filed on Feb. 7, 2012.

(51) Int. Cl. G06Q 10/10; G06Q 50/00

(52) U.S. Cl. CPC G06Q 10/1053; G06Q 50/01
USPC 705/321

(57) ABSTRACT

A system for generating and maintaining a private talent network (PTN) is described. The system allows a company to create and maintain a branded private talent network including a live talent pool of active job seekers and potential job applicants for company positions. The system includes tools for establishing, managing and developing relations with the talent pool within a private talent network as a whole or within sub-networks (circles), such as a capability to schedule and host events of interest to candidates and a capability to communicate with candidates via such methods as video, text messaging, announcements, discussions and email. In addition, the system provides tools for segmenting the recruiting process into multiple phases where each of the interactions with each candidate during each phase is tracked and information associated with the interactions is stored.

### CROSS-REFERENCE TO RELATED APPLICATIONS

This application claims priority under 35 U.S.C. §119(e) to U.S. Provisional Patent Application Ser. No. 61/596,058, titled “METHODS AND APPARATUS FOR A SOCIAL RECRUITING NETWORK,” filed Feb. 7, 2012 and this application claims priority under 35 U.S.C. §120 and is a Continuation-in-part of co-pending U.S. patent application Ser. No. 12/914,260, titled “METHOD AND APPARATUS FOR MANAGING AND CAPTURING COMMUNICATIONS IN A RECRUITING ENVIRONMENT,” filed Oct. 28, 2010, each of which is incorporated by reference in its entirety and for all purposes.

### FIELD OF THE INVENTION

This invention generally relates to social media applications, and more particularly to systems and methods that enable private social networks for job recruiting.

### BACKGROUND

Currently, companies maintain a presence on the web including a social media presence to help develop and maintain a “brand” associated with their products or services. Companies spend large amounts of money related to product and company branding because it can directly affect their sales and profitability. The expenditures can go towards such efforts as determining what type of product brand to project, assessing their current product brand relative to a desired brand, responding to threats to their product brand and coordinating advertising, such web-based advertising, to improve their product brand.

A company's reputation as a good or bad place to work is also part of their “brand.” A company with a good workplace brand attracts talented people. In particular, rather than having to find and recruit talented people, a company with a good work place brand has people seeking them out. For example, a company like Google™ which is rated as one of best companies at which to work receives hundreds of applications for every open job position and is able to be very selective in its hiring. Thus, good workplace branding can lead to reduced recruiting costs and to a higher quality talent pool from which to select employees.

As compared to product branding, companies spend much less time, effort and money on workplace branding. For example, the resources dedicated towards workplace branding for a company, such as determining what type of workplace brand to project, assessing the current workplace brand, responding to threats to a company's workplace brand and improving the workplace brand are much less than the resources dedicated towards the equivalent product branding efforts. This lack of expenditure occurs even though companies spend large amounts of money on employee recruiting which is directly affected by workplace branding.

Further, some employee recruiting processes can actually damage their workplace brand. For example, companies engaging in recruiting candidates for a job frequently post job description to job sites or otherwise make information about open jobs available on the web. From the perspective of a future employee, in response to a job posting, their first significant interaction with the company may be supplying information electronically, such as a resume, to demonstrate their interest. After submission, the candidate's information is often transferred to an applicant tracking system, which automatically filters out the vast majority of candidates. Then, a select few candidates are invited to interact with a live person, such as a company recruiter, and possibly interview with the company. However, most applicants never hear back from the company.

Most candidates find the lack of human interaction discouraging. In some instances, the lack of interaction causes candidates to even harbor antipathy towards the company decreasing their likelihood of seeking employment from the company in the future. Thus, rather than promoting a company's workplace brand, the initial job recruiting process actually hurts it. When the workplace brand is damaged, the potential talent pool available to a company is shrunk, the costs associated with recruiting increase and more resources may have to be spent to get employees to accept jobs, such as higher initial salaries or better benefits as compared to competitors with better workplace brands.

As described above, live interactions with current company employees, such as recruiters or other employees can be important towards building and maintaining a company's workplace brand. However, companies lack the ability to provide these interactions in a cost effective manner to every person interested in working for the company. Thus, potential employees, unless they are fortunate enough to know someone currently employed in a company of interest, very rarely get to interact with company employees.

One reason potential employees seek out live interactions is because they want to gain firsthand knowledge of what it is like to work for a company, i.e., assess the companies workplace brand. When a company doesn't make these live interactions readily available then potential employees turn to other sources to gain firsthand knowledge. One common example of an information source is third-party blogs. There are many third-party blogs on the web set-up to receive comments from people that have had live interactions with various companies, such as individuals that have interviewed and failed to get a job or have worked and then left the company for some reason. Via these third-party blogs, it is likely a person seeking employment at a company will learn negative things that are detrimental to the company's workplace brand. Again, damage to a company's workplace brand can increase job recruiting costs, lower the quality of the talent pool from which employees are selected and increase initial hiring costs.

In view of the above, improved methods and apparatus are needed that provide live interactions and firsthand knowledge related to recruiting and workplace branding in a cost effective and efficient manner.

### SUMMARY

A system for generating and maintaining a private talent network (PTN) is described. The system allows a company to create and maintain a branded private talent network including a live talent pool of active job seekers and potential job applicants for company positions. The system can be configured to interact with outside social media sites to leverage existing social media data and spread information, such job related information, in a viral manner. When approved by the user, the system can be configured to keep candidate information fresh by regular checking outside sites for new information, such as new talent related or contact information.

The system includes tools for establishing, managing and developing relations with the talent pool in the private talent network, such as a capability to schedule and host events of interest to candidates and a capability to communicate with candidates via such methods as video, text messaging and email. In addition, the system provides tools for segmenting the recruiting process into multiple phases where each of the interactions with each candidate during each phase is tracked and information associated with the interactions is stored. Using the tools, a company can be assured that the recruiting process is applied in consistent manner to each candidate.

A management interface for the private talent network allows an assigned administrator to brand the private talent network, specify its organization structure, create mini-talent networks (circles) within the private talent network, assign people to the circles, generate message and announcements, schedule events and generate e-mail campaigns. Further, the system can include interfaces for exporting data from or into a company's existing applicant tracking system. Also, join widgets are provided that easily integrate into a company's web pages. The join widgets allow individuals to sign up to join the company's private talent network.

In more detail, tools are provided to manage the end-to-end screening and interviewing processes. One tool is used to generate pre-recorded questionnaires. The questionnaires can be presented to candidates in different formats, such as textual, multi-choice or video formats. Video of candidates answering the questions can be captured, reviewed and sometimes scored to filter candidates for additional interaction. The system includes administrative features that allow a team leader to assign to different reviewers candidates for review and then keep track of whether the review process has been performed by these reviewers.

As another feature, the system provides a video interface for live one-on-one or group video interviews. The video interface is tailored to recruiter needs and includes a capability to schedule meetings, upload documents for discussion, search for candidate information on the fly during an interview and record comments that are only visible to recruiters and similar users of the system. Besides interviewing, the video capabilities can be used for general interactions with candidates as well as to host events, such as webinars.

The private talent network can be provided as a stand-alone system that is easily integrated into a company's existing recruiting systems. In one embodiment, the system can be implemented using a distributed cloud architecture. The cloud architecture can include system components for hosting the private talent network, interfacing with an Applicant Tracking System (ATS), hosting e-mail communications, hosting video communications and interfacing with social media sites.

### BRIEF DESCRIPTION OF THE DRAWINGS

The included drawings are for illustrative purposes and serve only to provide examples of possible structures and process steps for the disclosed inventive systems and methods for providing game services to remote clients. These drawings in no way limit any changes in form and detail that may be made to the invention by one skilled in the art without departing from the spirit and scope of the invention.

FIG. 1 is a block diagram of a recruiting system for candidates and recruiters including a private talent network in accordance with the described embodiments.

FIG. 2 is a block diagram of a recruiting system including a private talent network implemented in the cloud in accordance with the described embodiments.

FIG. 3 is a flow chart of a method for registering an individual in a private talent network in accordance with the described embodiments.

FIG. 4A is an illustration of a company career web page in accordance with the described embodiments.

FIG. 4B is an illustration of a job description web page in accordance with the described embodiments.

FIGS. 5A and 5B are illustrations of a company career web page including an activated private talent network registration widget in accordance with the described embodiments.

FIG. 6 is a flow chart of a method for configuring a private talent network in accordance with the described embodiments.

FIG. 7 is an illustration of a configuration page in a private talent network in accordance with the described embodiments.

FIG. 8 is an illustration of a welcome page in a private talent network in accordance with the described embodiments.

FIG. 9 is an illustration of a candidate home page in a private talent network in accordance with the described embodiments.

FIG. 10 is an illustration of a recruiter home page in a private talent network in accordance with the described embodiments.

FIG. 11 is an illustration of a company page for a private talent network in accordance with the described embodiments.

FIG. 12 is an illustration of a candidate profile page in a private talent network in accordance with the described embodiments.

FIG. 13 is an illustration of a candidate profile page as viewed by a recruiter in a private talent network in accordance with the described embodiments.

FIG. 14 is an illustration of a search page for a recruiter in a private talent network in accordance with the described embodiments.

FIG. 15 is a flow chart of a method for interviewing using a questionnaire in a private talent network in accordance with the described embodiments.

FIG. 16 is an illustration of a questionnaire configuration page in a private talent network in accordance with the described embodiments.

FIG. 17 is an illustration of a welcome page for a video interview including a questionnaire in a private talent network in accordance with the described embodiments.

FIGS. 18A and 18B are illustrations of questionnaire pages used in an interview process in a private talent network in accordance with the described embodiments.

FIG. 19 is a flow chart of a method of generating interviews in a private talent network in accordance with the described embodiments.

FIGS. 20 and 21 are illustrations of video interface pages in a private talent network in accordance with the described embodiments.

### DESCRIPTION OF THE PREFERRED EMBODIMENTS

The present invention will now be described in detail with reference to a few preferred embodiments thereof as illustrated in the accompanying drawings. In the following description, numerous specific details are set forth in order to provide a thorough understanding of the present invention. It will be apparent, however, to one skilled in the art, that the present invention may be practiced without some or all of these specific details. In other instances, well known process steps and/or structures have not been described in detail in order to not unnecessarily obscure the present invention.

One architecture described herein that can be leveraged to provide a more cost-effective and efficient way to interact with a potential job candidate and increase a company's workplace brand can be referred to as “Social recruiting.” Social recruiting is a way for sourcers and recruiters to leverage technology to scale what's part of their DNA: create relationships, facilitate and encourage connections with and between people, communicate the brand identity, its purpose, and its values, and identify talents to whom hiring managers will relate.

Social recruiting can involve establishing a private social network. When companies compete for the top 1% in whatever category (the best engineers as well as the best administrative assistants) and sometimes 50% of employees are actively seeking or open to a new job, how can you intercept and nurture the attention of potential candidates? One way is for companies to create a hub for people and information. This hub for people and information can involve welcoming candidates into a trusted private social network where recruiters can maintain a bond between the brand they represent and the people. Within the private social network, an environment conducive to focused interactions between a company and the candidates that fosters continued engagement and enables recruiters to meet, retain and select people who show true interest in the company's culture and its values can be created.

One component of a social recruiting network can be a private talent network that is set-up for a particular company. A member of the private talent network can maintain a profile, interact with recruiters and gain firsthand knowledge about a company. For example, chats or seminars by current employees engaged in developing company products can be provided in the private talent network. The private talent network can be configured to inform members of upcoming events and provide a platform for participating in events. Further, the members of the private talent network can view job postings where the system allows the members to share job posting with members or non-members of the talent network.

Staff within the private talent network can send and respond to messages from candidates within the private talent network, schedule public and private one-on-one or group video meetings and webinars. Video meetings can be recorded, subsequently accessed and forwarded to hiring managers. Staff can create questionnaires where a video recording of candidates answering questions can be saved for subsequent review and scoring. The staff can see candidate profiles and add tags or comments to the profiles that are only visible to other staff members but not the candidates themselves. The staff can manage job posting, receive applications from candidates and search within the private talent network for qualified candidates.

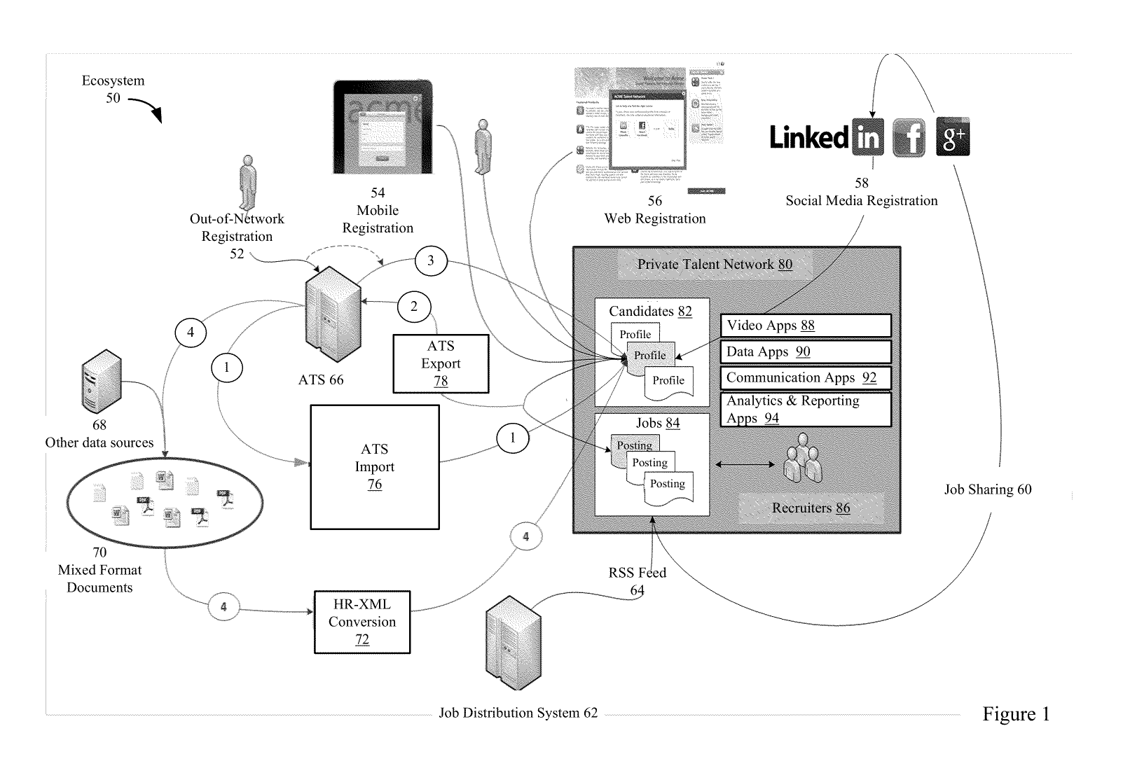

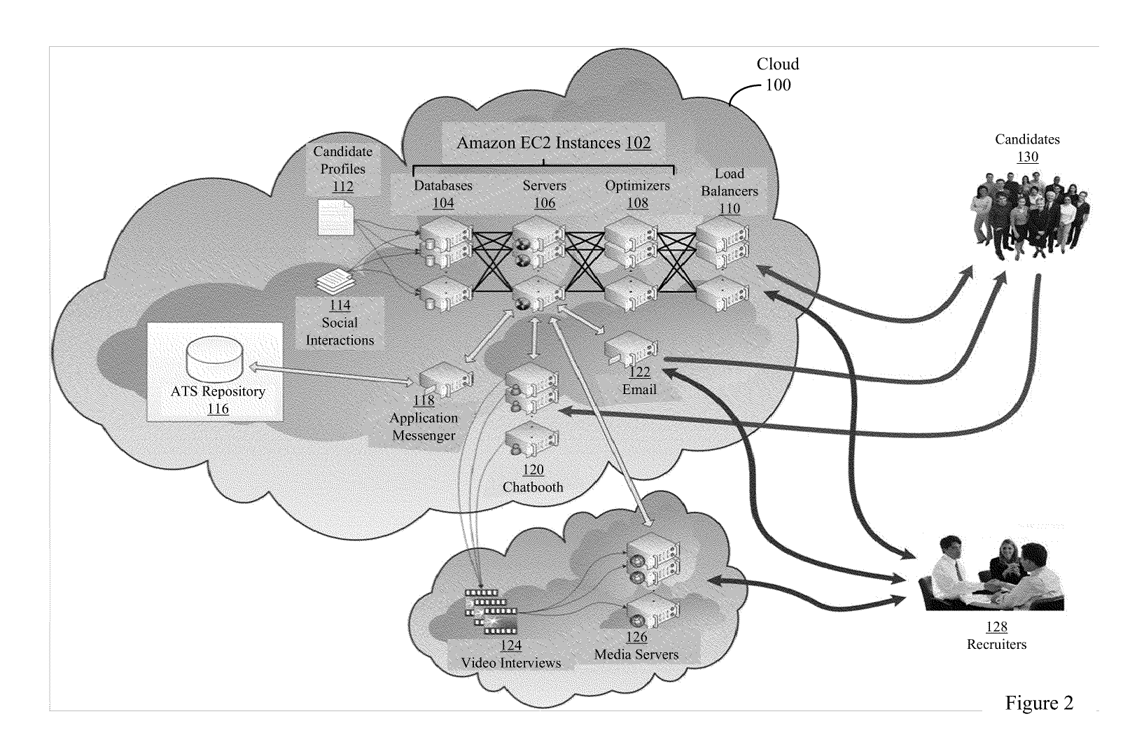

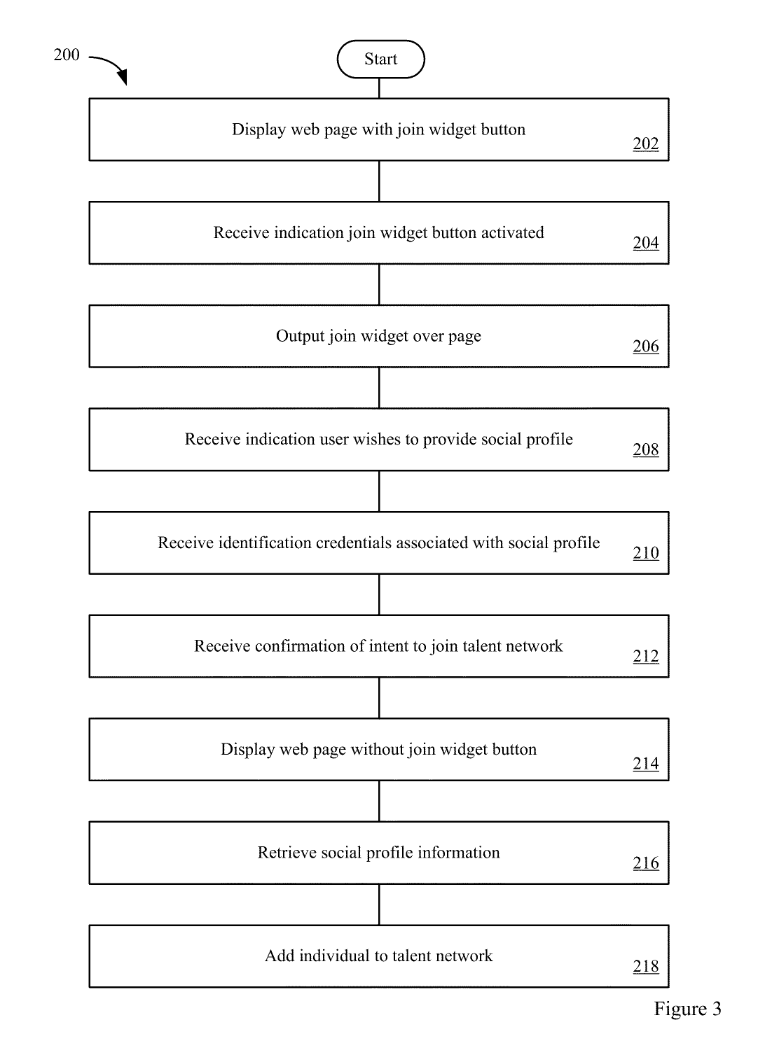

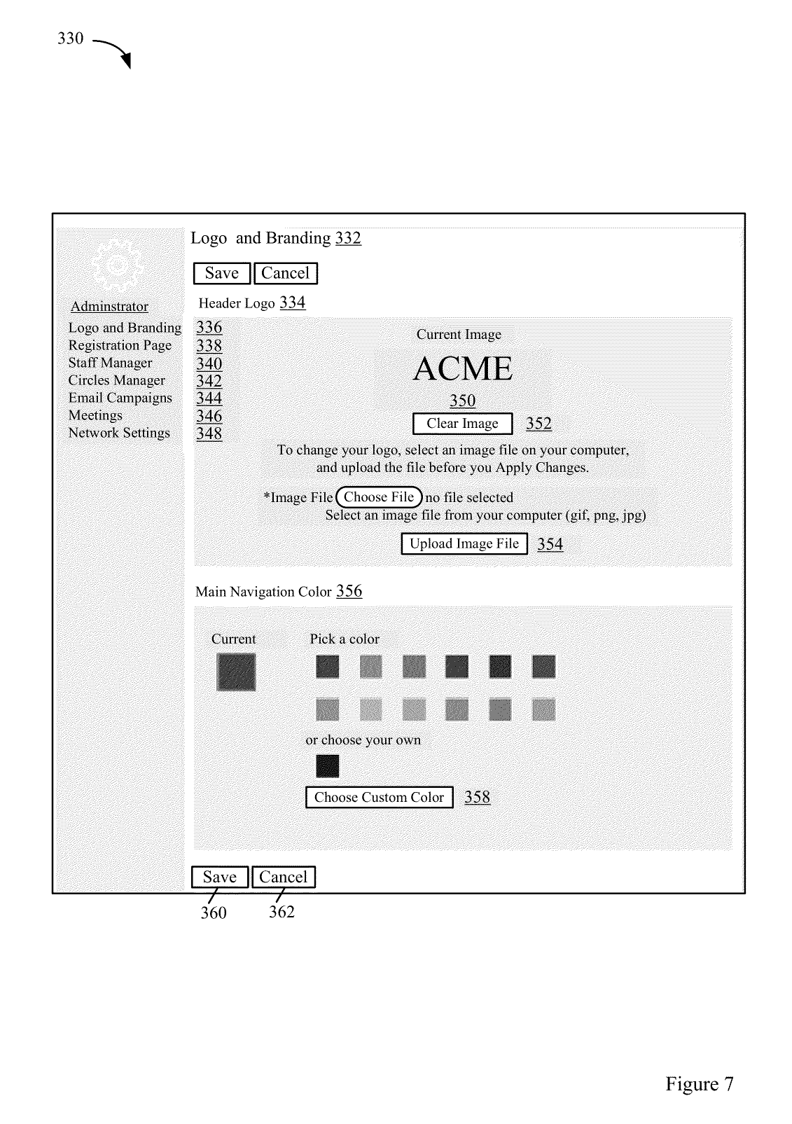

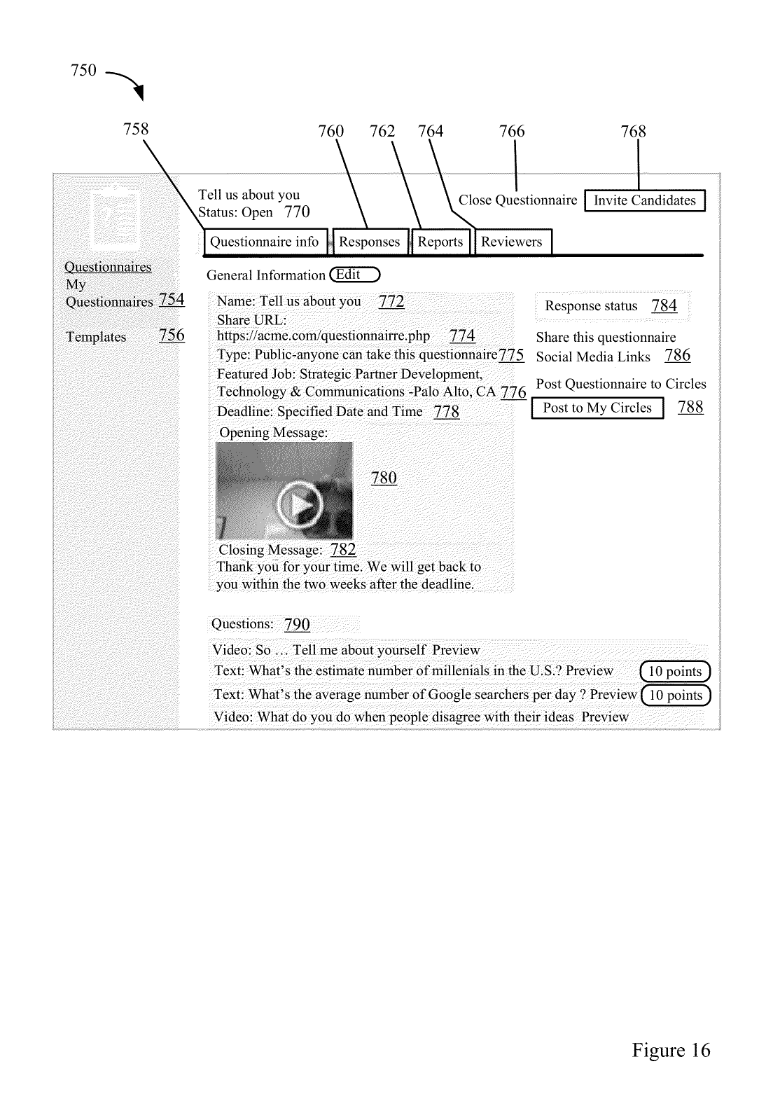

Further details of an architecture for generating and managing a private talent network that can be used in the embodiments described herein is discussed in more detail with respect the following figures. In particular, an overview of the system is described with respect to FIGS. 1 and 2. A join widget that can be integrated into a company's existing web-pages is discussed with respect to FIGS. 3, 4A, 4B, 5A and 5B. The join widget allows a user to join widget the private talent network using an existing social media account. Methods for creating and managing a private talent network including example pages associated with the private talent network are discussed with respect to FIGS. 6-14. Finally, methods for conducting video interviews including generating questionnaires and conducting live video interviews are discussed with respect to FIGS. 15-21.

### System Overview

A recruiting ecosystem 50 including a private talent network (PTN) 80 is discussed with respect to FIG. 1. The PTN 80 can be configured to provide 1) video interviewing, recording and sharing 88, 2) hosting of live events, 3) managed recruiting campaigns 92, 4) tools for managing member profiles 82, events, searches 90 and analytics 94, 5) tools for managing a company's social media presence, such as a company's Facebook™ page, 6) tools for data sharing 90 and collaboration between recruiters 96 and hiring managers and tools for posting and managing job posting 94. A company can own its PTN 80, just as it owns its intranet or knowledge management platform. As a result, the security and privacy of its interactions with candidates as well as the information that is exchanged is ensured.

In one embodiment, the PTN 80 can be configured to allow the creation of networks (“circles”) of member candidates. The circle creation tool can be one of the data applications 90. As an example, a circle of candidates interested in engineering can be created. As another example, a circle of candidates interested in human resources can be created. Via the circles, candidates can be provided with continuous engagement on a one-to-one basis, in groups or through live events that are of interest to the candidate. In addition, the talent network can be configurable to manage candidates' interactions and share them with recruitment life cycle decision makers.

One aspect of a PTN 80 and social recruiting is the mechanisms that allow a person to learn about and join the talent network. As shown in FIG. 1, in particular embodiments, a person can be directed to a company's talent network via career sites, job boards, and other company sites 56. A join widget which is easily incorporated into any existing web page can be provided. The join widget allows an individual to join the company's private talent network. In general, the join widget can be integrated into web pages with content of all different types and is not limited to web pages with job or career type Additional details of the join widget are describe with respect to FIGS. 3-5B.

In particular embodiments, an interface including a “join” button can be used to provide an entry pathway into a company's talent network. The join interface can be designed as a code segment that is easily embeddable into a web-page. For example, the code segment can be constructed in a mark-up language that is web-browser compatible. In other embodiments, the join interface can be integrated into a custom application, such as a custom application executed on a mobile device 54. As an example, a custom application executing on a tablet computer, such as an iPad™ can be used to register members in a PTN 80 and create new member profiles 82 at an event such as job fair or developer conference.

The join widget or other types of interfaces providing registration capabilities can be integrated into social network sites 58 that are web accessible. Examples of social network sites include but are not limited to LinkedIn™, Facebook™ Google+™ and Twitter™. In one embodiment, a dedicated company web-page can be provided on the site which allows an individual to be introduced to the company and then join the company's PTN 80 if they wish.

Another aspect of the PTN 80 is the capability to import and export data and interact with outside entities residing on public networks. As an example, the talent network can be coupled to an applicant tracking system 66 that stores candidate data. In one embodiment, denoted by pathway 1, the PTN 80 can include an ATS import interface 76 that allows legacy candidate data stored in the ATS to be translated into a format acceptable by system 80.

In one embodiment, the legacy candidate data from the ATS 66 can be used to generate candidate profiles 82. In one embodiment, the new candidates can be automatically enrolled in the PTN 80 and a notification message can be sent to the new candidates of their status in the private talent network and this notification message can recommend that they update their status. As will be described in more detail below, the candidates can be invited to link an outside social media account to their profile at system 80. In another embodiment, rather than automatic registration, the candidates can be sent an invitation to join the network 80.

An existing ATS 66 can have interfaces to a number of outside sources, such interfaces for applying for a job and submitting resume. Out-of-network registration 52 can involve leveraging these existing interfaces. For example, a job applicant interface to an ATS can be modified to allow an individual to also join the PTN 80. As another example, the job applicant interface can be modified to convert and send data to PTN 80 to generate a candidate profile 82 via pathway 3. In another example, an interface can be added to the ATS such that after it receives information it can be converted and sent to the PTN 80.

In some instances, a candidate may create a profile and apply for a job through the PTN 80 as opposed to an interface directly coupled to the ATS 66. In this example, the PTN 80 can include an interface 78 that converts the data received from the PTN 80 to a format compatible with the ATS 66. The format that is used can be ATS specific. Thus, different PTN's, such as 80, can utilize different export formats depending on the database structure of the ATS 66. Pathway 2 shows the export of data from the PTN 80 to the ATS 66 via the ATS export interface 78.

In another embodiment, data from the ATS 66 or other outside data sources 68, such as legacy data not entered into an ATS, can be in form of paper or electronic documents, such as resumes. These documents may be in different formats 70, such as different file types (e.g., word or pdf) and different information arrangements. The PTN 80 can include an interface for performing a human resources xml conversion 72 and importing the converted data to populate candidate profiles 82 within the PTN 80. HR XML is an open standard for data exchange geared towards human resource applications. The conversion of legacy data to an HR-XML format from an ATS 66 or from another outside data source is shown via pathway 4.

Currently, when candidates immediately become applicants, their resumes are stored in ATS dark rooms and resumes become stale quickly. Via the tools provided by the PTN 80, a more accurate description of candidate skills and capabilities can be maintained. The candidate skills can be matched to newly opened job positions without the candidate having to resubmit a resume.

The PTN 80 can be configured to allow regular updates of the information in the applicant tracking system. The profiles can be continuously updated by the candidates either manually or automatically if they choose to link to their LinkedIn™ or Facebook™ profiles, or any other public social networks that candidates may use, such as Google+, Quora, etc., as well as personalized or socialized sites or blogs. The updates can occur via an API provided by the particular social media site. In particular embodiments, an individual can link their PTN profile to one or more different social media sites. Thus, the PTN 80 can be configured to interface with multiple different social media sources which can vary from person to person.

In general, the PTN 80 can be configured to link to any accessible data source where an individual maintains some type of personal information. The data source doesn't have to be a social media site. For example, some sites allow an individual to maintain personal information which are not social media sites. In addition, the PTN 80 can link to data aggregation services not controlled by the individual if the data provided by the service is considered reliable.

In one embodiment, the PTN 80 can provide tools for sharing jobs 60. The tools may allow a PTN member to share job information with other members of the PTN 80 or non-members, such as their friends on social media sites, via email, text or any other suitable communication mechanism. Thus, the PTN 80 can include interface for interacting with social media sites to import data, such as job related data.

The sharing of PTN 80 related data can be used in viral marketing applications. The viral marketing can involve a sharing mechanism that allows information internal to the company's private talent network to be shared with public web-sites, such as other social media sites if so allowed by the company owning the private talent network. For example, via the sharing mechanism, members of the company's private talent network may be able to share information that is displayed within the company's private network, such as a job posting or a notice of an upcoming event, with their friends or acquaintances on the public networks, via email, text or any other suitable communication mechanism.

Another source of data that can be imported into the PTN 80 is RSS feeds 64. RSS (Rich Site Summary, often dubbed Really Simple Syndication) is a family of web feed formats used to publish frequently updated works—such as blog entries, news headlines, audio, and video—in a standardized format. An RSS document, which is called a “feed”, “web feed”, or “channel,” includes full or summarized text, plus metadata such as publishing dates and authorship. The imported RSS feeds 64 can be routed to different members of the PTN 80. Certain RSS feeds 64 can be routed to particular groups of users, such as a group of users in a circle within the PTN 80.

Next, one embodiment of a system infrastructure for implementing a PTN 80 is described. FIG. 2 is a block diagram of a recruiting system including a PTN implemented in the cloud in accordance with the described embodiments. A number of instances 102 of different PTNs can be executing simultaneously in the cloud. The instances 102 can be instantiated on a cloud network infrastructure, such as an Amazon EC2 (Amazon elastic compute cloud). The cloud network infrastructure can include databases 104, servers 106 and optimizers 108 that interact with load balancers 110 to provide outside interfaces to candidates 130 that are members of the one or more different PTNs. As an example, interfaces for viewing candidate profiles 112 and generating social interactions can be provided to both recruiters and candidates.

The PTN executing in the cloud can interface with an application messenger 118. The application messenger can provide communications between an ATS repository 116 and a particular PTN instance. Different PTNs can communicate with different ATS repositories. Thus, one or more different instances of the application messenger 118 can be provided.

Media servers 126 can be provided for performing video interviews 124 and other communications involving video data. The video communications can be provided in a chat booth implemented on a server 120. As described below, communications with the PTN instances can allow data and documents to be search, retrieved and uploaded, such as candidate profile information, while the video chat booth is being generated and communications between a recruiter 128 and one or more candidates are on-going. Another media application can be webinars and other types of group discussions or public forums.

### Join Widget for a Private Talent Network

Next, a registration widget for private talent network are described with respect to FIGS. 3, 4A, 4B, 5A and 5B. In particular, a join widget including a “join” widget button is described. The “join” widget button can be used to initiate a registration interface for a company's private talent network. As will be described in more detail below, the join widget can be designed as a code segment that is easily embeddable into a web-page. For example, the code segment can be constructed in a mark-up language, such as version of HTML, that is web-browser compatible. Thus, the registration widget can be easily integrated into a company's existing web infrastructure. In other embodiments, the registration widget can be integrated into a custom application, such as a custom application executed on a mobile device.

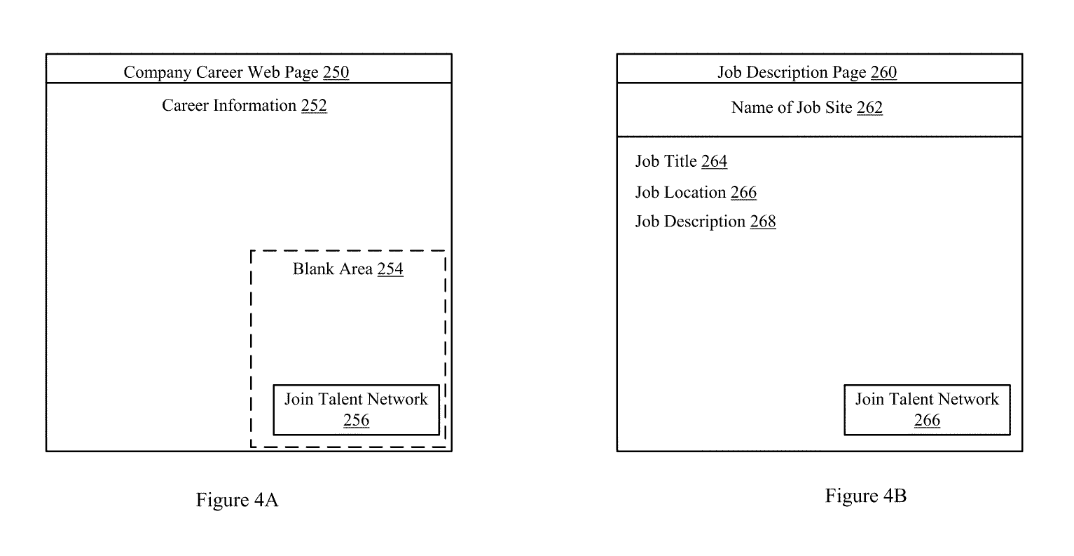

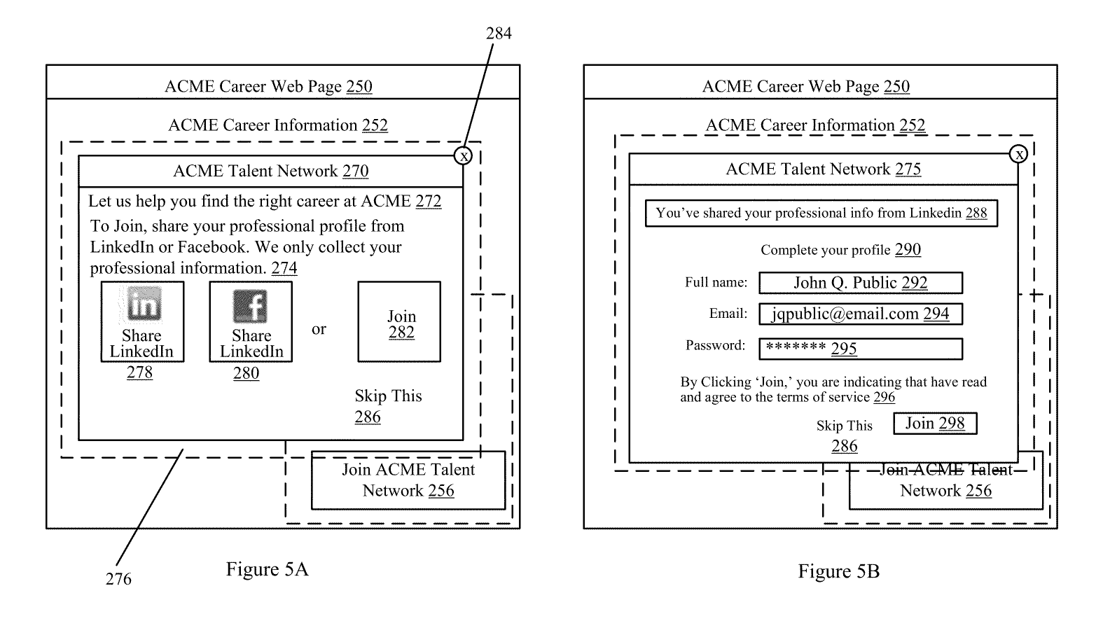

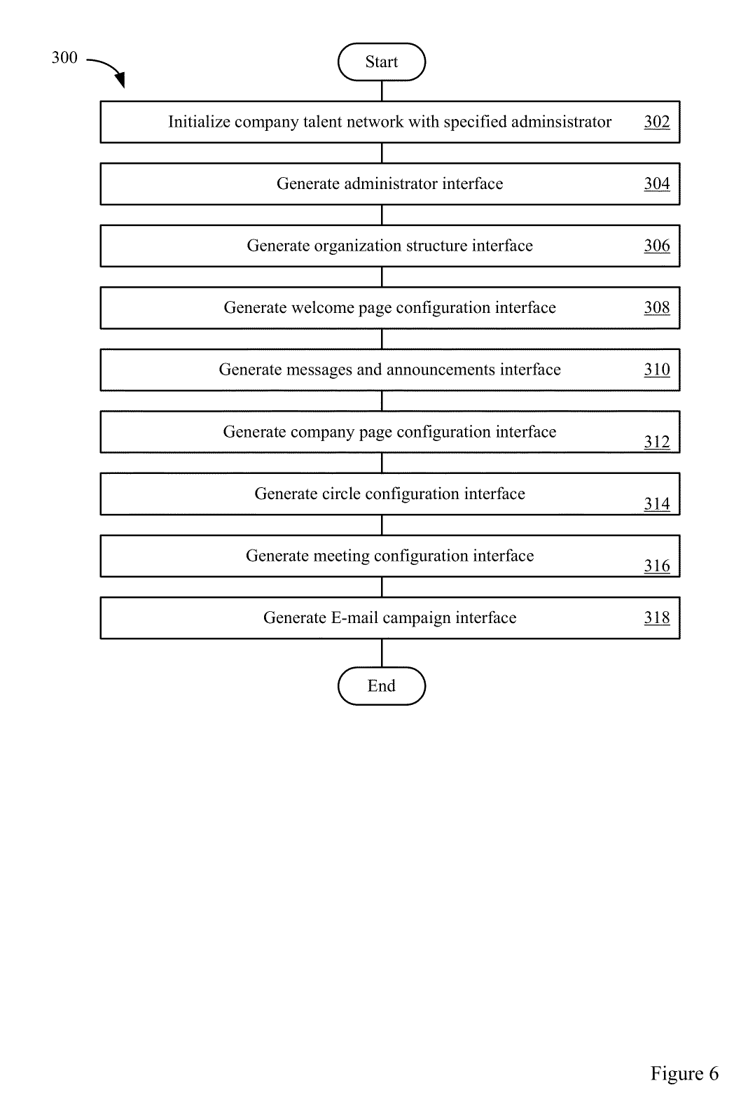

FIG. 3 is a flow chart of a method of registering for a company's private talent network using a join widget. In particular examples, as will be described in more detail with respect to FIGS. 4A, 4B, 5A and 5B, the join widget button can be integrated into a web page including content describing a particular company or a web page including a job description. In general, the join widget button can be integrated into any type of web page.

In addition, multiple join widget buttons can be integrated into a single web page. For example, a web page can include multiple join widget buttons each associated with a different company. By selecting the join widget button for a particular company, an individual can register to join a private talent network for the particular company. If the individual wishes, the process can be repeated for multiple companies allowing the user to join separate private talent networks for multiple different companies.

In 202, the jobseeker can arrive at a website where a web-page includes the join widget button. The jobseeker may navigate to a page of interest, such as a page containing a job description. A join interface can be integrated into the web-page which includes a “join widget.”

The person doesn't necessairily have to be a job-seeker or be a candidate for a job. Instead, the person may be simply be interested in the company for some reason, such as wishing to be employed in the company in the future or simply to learn more about the company. Thus, the term “jobseeker” is used for illustrative purposes only is not meant to limit the method to only individuals that are currently seeking jobs.

In 204, the jobseeker can trigger the join widget. In response, in 206, an interface can be generated that enables the job seeker to share a pre-existing social profile to join the private talent network. For example, the job seeker can share their Linkedin™ profile. If the jobseeker doesn't wish to share an existing social profile, then an interface can be provided that allows the person to join by manually entering the required information.

In one embodiment, in 206, when the join widget is triggered from a web-browser at a web-site, secure communication connection can be established with a remote web-site, such as a web-site hosting a private talent network. A script can be launched on the remote site that generates an interface which allows the jobseeker to select a source of a pre-existing profile, such as a job related profile from LinkedIn™ or Google+™.

In 208, an indication can be received that the jobseeker wishes to share from an existing profile. In respone, an interface page can be generated that allows the jobseeker to provide identification credentials associated with the selected social profile. In 210, the system can receive the identification credentials associated with the selected social profile.

Next, in 212, the system can generate a selectable button that allows the jobseeker to indicate that they wish to join a private talent network. Upon receiving approval, the registration process can be completed and the original web-page from which the join widget was launched can be returned to original state. In one embodiment, the join widget button can be removed from the web-page if registration was successful. In another embodiment, the join widget button can be replaced with a button that allows the jobseeker to navigate to the private talent network which they joined. In yet another embodiment, after registering, the jobseeker can be placed at a page associated with the private talent network. The join widget can include parameters that allows a user to select one of these options.

Upon receiving job seeker approval to join and upon a successful verification of the credentials provided to the user, in 216, information associated with the pre-existing profile can be imported to the private talent network to establish a user profile on the private talent network. Thus, the jobseeker doesn't have to re-enter all of their profile information. In one embodiment, the system can import the information via an API (application program interface) provided by the social media site. If the credentials are not verified (e.g., wrong password), then the system can generate a warning message that requests the information again.

The system can be configured by the company and/or by the job seeker to not import all of a jobseeker's information that is available. For example, to protect the jobseeker's privacy choices, the system may avoid importing other types of information that may be available, such as status posts from the jobseeker's wall on Facebook™. The system can be configured to import only the information related to the context of a person's participation on the private talent network. For example, if the participation is related to employment opportunities at a particular company, then information of interest in an employment scenario can be imported, such as location of the individual, education level and past employment details.

In particular embodiments, the system can generate a button that allows the user to view what type of information is to be imported and under what conditions. For example, the system can be configured to repeatedly revisit the site hosting the social profile to keep it up to date. Thus, the system can be configured to display that the system will repeatedly visit the site to update their information. In another embodiment, an option can be provided such that the retrieval of information is only performed once or over some limited time period and the system can display that these options are enforce. In yet another embodiment, the system can be configured to allow the user to manually trigger an update so that it is immediately available within the private talent network and the system can display that this option is available to the user.

In yet other embodiments, the system can provide options to allow the user to join at different interest levels. The level that the person joins can be expression of their interest level. For instance, the system can be configured to allow the person to join at a “casual” level to learn basic information about the company where the person is not necessarily interested in a job. In this embodiment, only basic information may be collected about the person, such as their name, location and contact information. In another instance, the system can be configured to allow the person to join as a “jobseeker” in which case the system can collect job related information.

In some embodiments, access to certain features in the private talent network can be accorded based upon the interest level expressed by the person at registration. For example, a person that registered with casual interest may be able to view basic company information and see events related to certain topics, such as webinars providing basic information, but may not be able to see job related information on the site or circles that the person could join. Whereas, a person that registered with a jobseeker interest may be able to see job seeker related information, such as information jobs available at the company, possible interviews that are available or circles that can be joined.

After joining, the system can provide the option of allowing the user to change their interest level and in response, collect additional or different information that is associated with their interest level. As will be discussed in more detail below, the private talent network allows a number of circles to be configured which are subgroups within the private talent network. The circles can be used to place individuals in different groups according to their expressed interest at registration. For example, a first circle can be created for “casual” members of the private talent network and a second circle can be created for “jobseeking” members of the private talent network. Or, another example, a circle can be created for persons interested in engineering, or in sales, or any functional area within a company.

Returning to FIG. 3, in 218, after the jobseeker is made a member of the private talent network, the jobseeker can be allowed to access features of the private talent network, such as viewing recruiter profiles, interacting with recruiters, participating in company events and accessing company information. Further, a profile can be created for the person on the company's talent network. Then, as described above, the jobseeker can continue to navigate on the current web-site or can be directed to a web-site associated with the company's private talent network.

Next, a visual walk through of the process is described with respect to the following figures. This walk through is presented for the purposes of illustration is not meant to be limiting. In FIG. 4A, an individual has arrived at a company page 250. The company page includes the selectable button labeled “JoinTalent Network” 256 as well as details about the company 252. The button 256 has been located in a blank area 254 associated with the page.

The location of the button can be a selectable option in the join widget. When the original formatting of the page includes an area suitable for a button, such as 254, then no reformatting may be required for the page. If the original formatting is not suitable for a button, then some reformatting may have to be performed on the original page to allow placement of the button.

In another example, in FIG. 4B, the individual has arrived at a job description page 260 of interest on a job board site 262. The job posting page 260 includes a job description with a title 264, location 266 and description 268. In addition, a “Join Talent Network” button 266 is included. Although not shown, an “apply now” button can be included where selection of the apply now button can cause an interface to be generated that allows the user to enter information and apply for a job.

A selection of the “JoinTalentNetwork” button 266 can cause a join interface to be generated that allows the individual to join and quickly establish a profile on the company's private talent network as described above. In this embodiment, the individual doesn't have to apply for the job to join the company's private talent network. In another embodiment, the “Join Talent Network” button 266 can be provided on a web-page that appears after the user has selected the “apply now” button. Thus, the user is required to enter the application information and select the “apply now” button before they are afforded the opportunity to join the private talent network.

At a job site, job descriptions of jobs from multiple different companies can be provided. When the “join” button is provided with a particular job description, a selection of the button can trigger an interface that allows the user to join the company's private talent network associated with the job description that is currently being viewed. If the job site supports job descriptions from different companies that each support private talent networks then it may be possible for the user to join a number of different private talent networks by perusing through the job site. As another embodiment, as described above, a single page can be provided that includes multiple buttons for joining different private talent networks associated with different companies. In one embodiment, an individual may be required to separately join each private talent network and may not be able to join allow the join private talent networks from a single registration process.

In one embodiment, the “Join Talent Network” button 266 can be a floating button in HTML. The text on the button is provided for illustrative purposes only. In other embodiments, a site administrator can select an image and/or text of their choosing for the button (e.g. see sample code below).

After the “Join Acme Network” button is selected, the interface component 270 shown in FIG. 5A can be generated. Via this interface component 270, the user can select an existing profile from another social media site to be shared. For example, the “Linkedin” button 278 or the “Facebook” button 280 can be selected to share information from an existing profile on one of these sites. Optionally, the user can simply select the “Join” button 282 to advance to an interface state that allows them to manually enter registration information. For example, the individual can fill in any missing information needed to complete their profile.

In FIG. 5B, the LinkedIn button 278 has been selected and a second join widget state 275 is generated. On 275, prior to the user entering access credentials, an indication that the user has elected to share their information from Linkedin can be displayed (not shown). Then, via the page, the individual can supply access credentials for the social media site, such as their full name 292, e-mail address 294 and password 295. If the user has elected to share an existing profile from another social media site, the page can indicate whether the information was successfully retrieved. For example, in FIG. 5B, a message 288 is displayed that indicates the user has shared their profile information from any other network. If desired, the user can select a link 290 which allows them to add more information, such as information used to complete a profile.

Next, the user can indicate via the page that they accept the terms of service 296 for the company's talent network. The terms of service can indicate what information is to be collected and whether it will be collected once or repeatedly. In one embodiment, the terms of service are accepted when the user selects the join button 298. In another embodiment, a box can be provided that when checked indicates the user has accepted the terms of service. In one embodiment, as described above, a selectable indicator can be provided which allows the individual to select an interest level or input some other characterizing information. Based upon the selection made by the user, the user can be assigned to one or more different circles initially in the private talent network.

After selecting the join button, a social profile for the user is created in the company's talent network. As described above, the profile can be populated with data from a pre-existing social profile on another social media site that the individual has agreed to share. In particular embodiments, the company's private talent network can be configured to regularly update their profile with information from one or more other social media sites. For instance, if the user adds new information to their Linkedin™ profile or Facebook™ and the user has given the company's private talent network permission to access this information, the profile that has been created in the talent network can be automatically updated as they change their Linkedin™ or Facebook™ profiles. In the case of Facebook™ that can include private as well as professional information, the private talent network can be configured to only access the professional information.

After joining the talent network, the individual can continue on the original page from which the private talent network was joined. For example, the individual can be directed back to the company page shown in FIG. 4A. On the company page, the “Join Talent Network” may no longer be displayed since the individual has just joined the talent network. As described above, in another embodiment, the individual can automatically be directed to the company's private talent network or given the option to go to the company's talent network. If the individual chooses this option, they can begin navigation on this site.

Next, an example code portion is described that is suitable for integration to a web-page. The code includes 1) parameters that allow the position of the button to specified, 2) a parameter that allows the image to be used for the join button to be specified and 3) a parameter that allows the return state to a specified URL. The return state is the page that is displayed after the script has been completed.

The JavaScript and PHP code can be used to generate the HTML code for the page that is used when the page is loaded, such as the interface pages shown in FIGS. 5 and 6. It can be run from the server side. The javascript can run from the client side within the local browser. In one embodiment, the javascript can be used to process the data that is entered via the two pages shown in FIGS. 5 and 6, such as but not limited to the selection of a site from which to obtain a profile, the users name and password.

### Example Code Portion:

```
<!-Join Widget Insert -->
<script type=″text/javascript″ language=″JavaScript″
src=″https://www.talentcircles.com/js/join widget.js″></script>
<script type=″text/javascript″ language=″javascript″>
  try{
    join_widget.debugFlag = true;
    // We want to see the bottom center button
    join_widget.buttons.bottomCenter.show = true;
    join_widget.buttons.bottomCenter.image = ′img/button.gif′;
    join_widget.buttons.bottomCenter.height = 40;
    join_widget.buttons.bottomCenter.width = 200;
    join_widget.dialog.closeBoxImage = ′img/close.gif′;
    join_widget.dialog.url = ′https://www.talentcircles.com/join_widget.
    php′;
    join_widget.dialog.crossDomainOrigin = ′https://www.talentcircles.
    com′;
    // Next page when the user clicks on the close box
    join_widget.dialog.followUpUrl = ′http://www.company.com/apply′;
    join_widget.startup( );
  }catch (e){
    if (typeof window.console != ′undefined′ && typeof window.console.
    log ==
    ′function′) {
      console.log(′join_widget.startup( ):′ + e);
  }
  }
</script>
<!-- End of ACME Widget Talent Circles Insert -->
```

One advantage of the join widget described above is the minimization or elimination of page switching. Existing solutions in the industry can require a job seeker to navigate between multiples pages (sometimes more than 5 page switches) to perform a registration action. With the join widget, the action of joining only triggers the injection of a registration screen INSIDE the current HTML page and may require no page switch at all because the return state can be the current page. In comparison, registration or logging in with LinkedIn™ or Facebook™ or other social networks requires at least one page switch. It has been observed that the elimination or minimization of page switching increases the likelihood of job seekers providing their profile. Thus, using the join widget, the percentage of potential candidate loss is drastically reduced compared to solutions involving labyrinthal navigation though many different pages.

### Methods for Generating a Private Talent Network (PTN)

Next details of creating and managing a particular instance of a PTN are described. First, a method for generating the PTN described. Then, a particular configuration of a PTN including example pages is discussed. FIG. 6 is a flow chart of a method 300 for configuring a private talent network. First in 302, the company talent network can be initialized with a specific administrator. The specified administrator is allowed to further configure the PTN. The initialization can include specifying network names, such as a domain name (e.g., acmenetwork.com) or a sub-domain name (acmenetwork@host.com) and network name (e.g., AcmeNetwork). The details are typically provided by a person in charge of a company web-site.

Then, in 302, a name, an e-mail address and a zip code of a network administrator can be specified. The management of the talent network is simple enough that a person that is not necessarily trained in site management, such as a manager of recruiting team, can be selected as the network administrator. If desired and permitted under licensing agreement, one or more additional users including name, e-mail and zip code can also be specified.

Next, in 302, a join widget can be installed. One or more join widgets can be integrated in existing company web pages, such as a welcome page for the company that is outside of the talent network. As described above, the join widget can trigger an interface that allows an individual to join the company's private talent network. The join widget can be integrated by a web designer or any other media agency that is familiar web design protocols. As part of the installation of the join widgets, the size, font, color and location of the join button on the page can be selected. As described in the previous section.

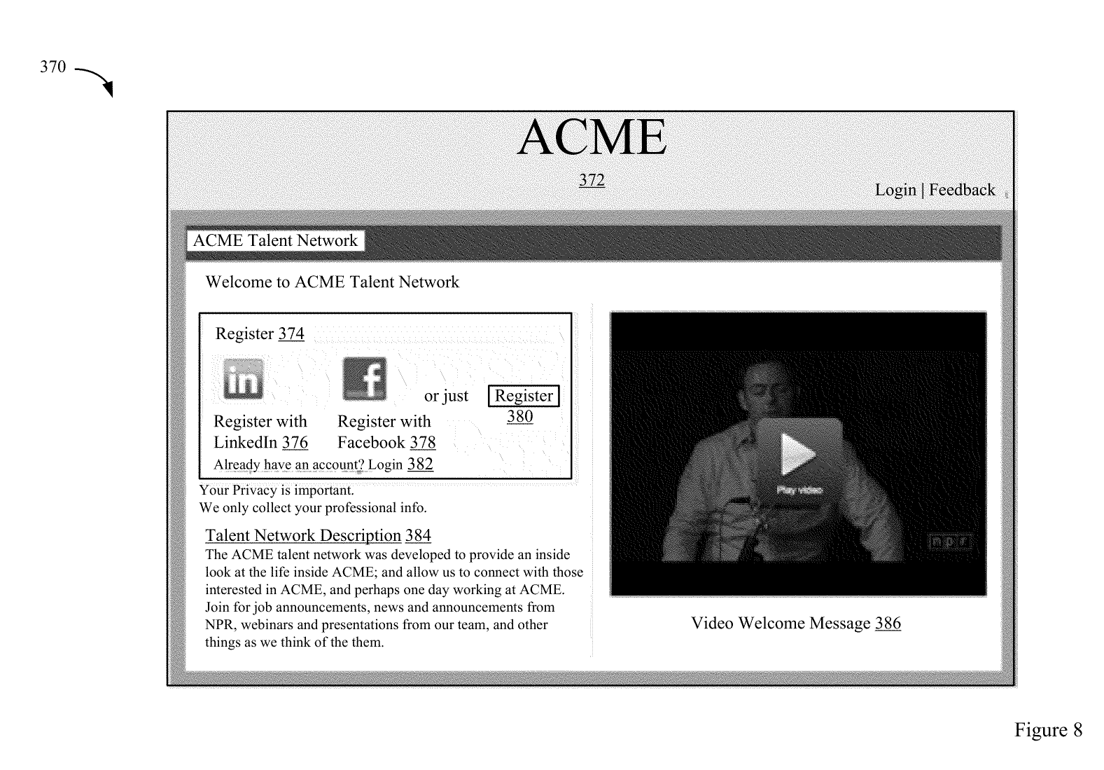

In 304, an administrator interface can be generated. An example of one administrator interface page is described below with respect to FIG. 7. The administrator is the person in charge of the look and feel of the private talent network. The network administrator can be a team leader, such as a recruiting team leader. Some of the tasks performed by a network administrator can include 1) one-off tasks that occur when the PTN is created, such as selecting and uploading branding information like a company log, 2) determining which members of a team to add to the system and what privileges the added members are to have on the system and 3) PTN management tasks, such as scheduling events and webinars, which are part of a continual engagement strategy with members of the PTN.

In 304, with the administrator interface, the administrator can specify their name and profile details and whether their profile information is to be available on the system. In one embodiment, the administrators or any staff member's profile information can be hidden upon selection of specific configuration settings. The administrator can also select limits to uploading documents for the system. During interactions with candidates one-on-one or in groups (within circles), the PTN allows an upload supporting documents. The administrator can specify who is allowed to upload documents.

In one embodiment, recruiters may not be allowed to upload documents. Further, it's up to the organization to decide if it allows its representatives to perform document uploads and to select the vetting process as far as the content of these documents is concerned. For example, only network administrators may be allowed to upload documents after the documents are vetted by a designated person in the organization. In another example, network administrators and company representatives may be able to upload documents after vetting is performed.

Another organizational choice which can be selected by the administrator is whether to allow recruiter reviews. The system can be configured to allow recruiting, hiring managers and other company representatives to rate candidates on a scale, such as a five point scale. This rating may be visible to other company representatives. In addition, company representatives may be able to leave detailed notes about a candidate. In 304, the network administrator can select whether this rating option is available.

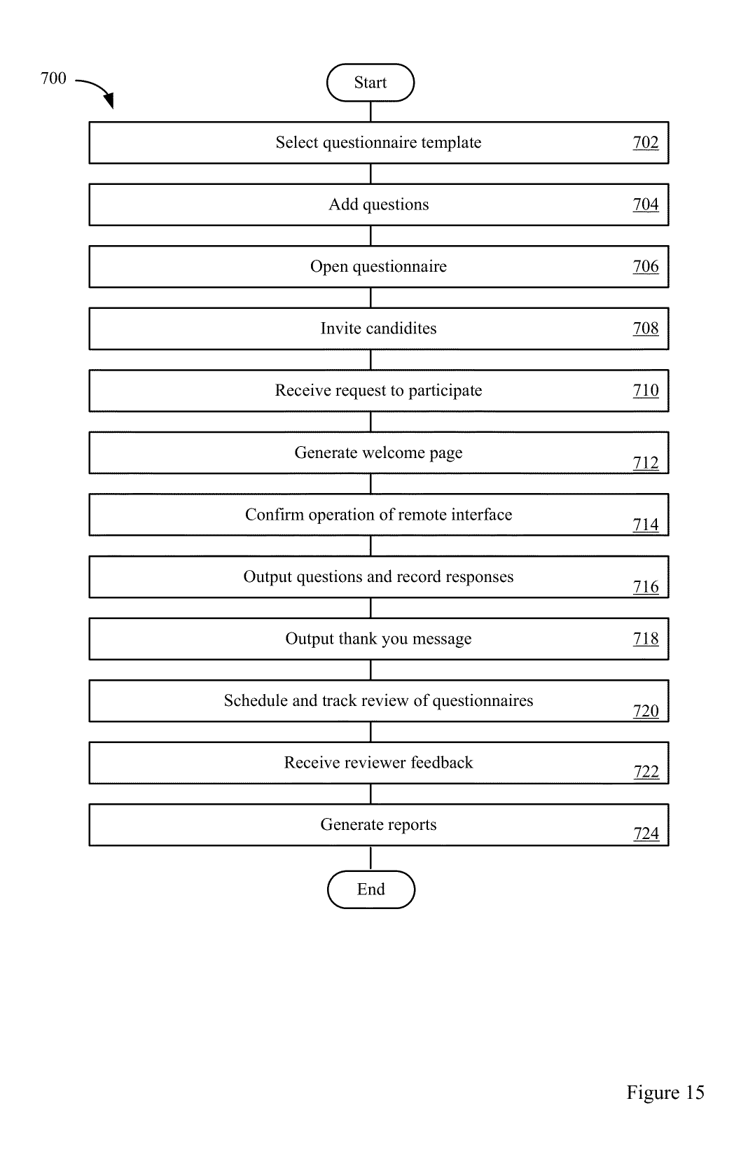

In another embodiment, the system can be configured to allow limitations on people searches within the PTN. The people searches can be performed over all of the profiles within the system. In one embodiment, only company representatives (staff) within the PTN can perform people searches. In another embodiment, all members of the PTN can perform people searches. In 304, via the administrator interface, the administrator can place limits on who can perform people searches, such as only company representatives, only a portion of company representatives, all members of the PTN or only a portion of the members (e.g., only staff and non-staff members within certain circles.) An example of an interface page that allows people searches is described with respect to FIG. 14.

In 306, an organization structure interface can be generated. The addition of a staff member can include specifying their name and e-mail. Then, the access level of the staff member can be designated. In one embodiment, the system is configured to allow multiple individuals to be designated with administrator privileges. Other privileges levels, such as representatives which have fewer privileges than an administrator, can be designated. The interface allows staff members to be suspended, unsuspended or deleted. The status level of each staff member, such as active or non-active can be displayed.

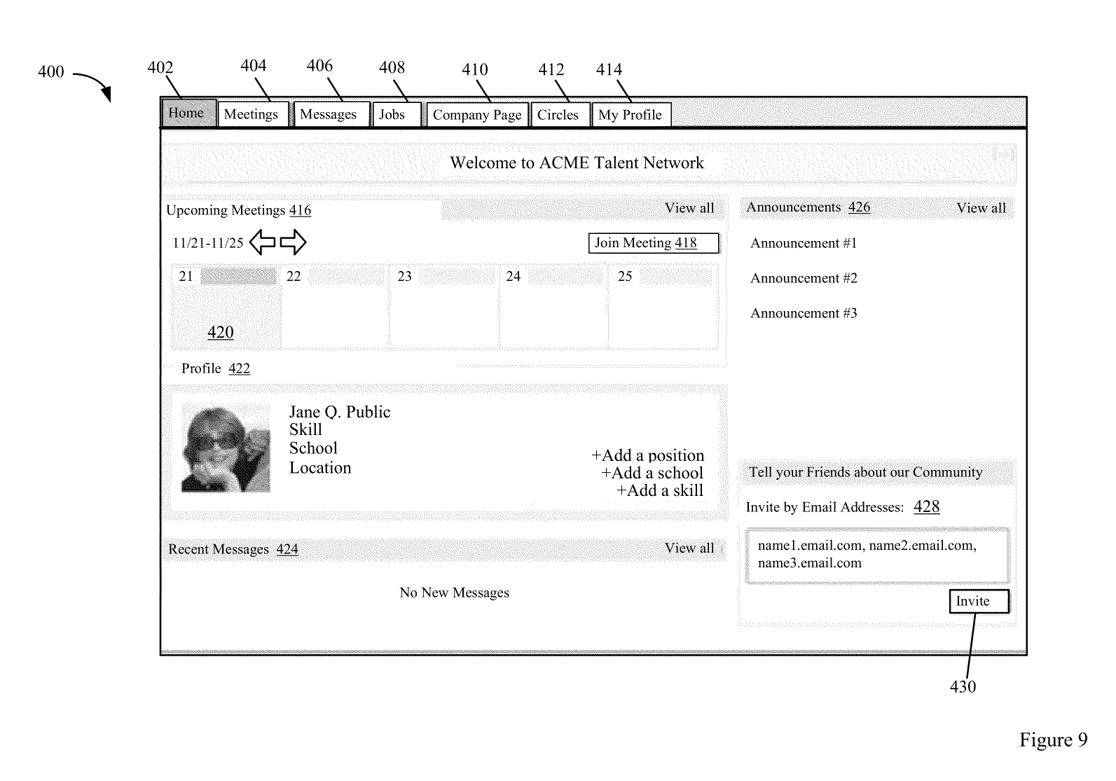

In 308, a welcome page configuration interface can be generated. The welcome page encourages individuals to register with the PTN. In one embodiment, via the interface, a text message can be entered that is displayed on the welcome page. In another embodiment, a video message that is playable on the welcome page can be uploaded via the interface. Typically, the video is two to three minutes long or less. In yet another embodiment, the system allows job postings to be optionally posted to the welcome page. The job postings may come from a direct feed associated with a job distribution system or may be entered manually. An example of a welcome page is described below with respect to FIG. 8.

In 310, a messages and announcements interface can be generated. Via the messages and announcements interface, messages and announcements may be manually entered into the system. The messages and announcements can be available to everyone or only available to certain groups, such as members within a circle, non-staff members or only staff members. The message and announcement recipients can be designated in the interface. Messages and announcements can be displayed on a member home page, a company page, circle pages or combinations thereof. In one embodiment, messages and announcements may be delivered via an automatic mechanism, such as an RSS feed. Via the interface, an administrator can specify a URL for a RSS feed that can be displayed on one of the PTN pages, such as on member home pages.

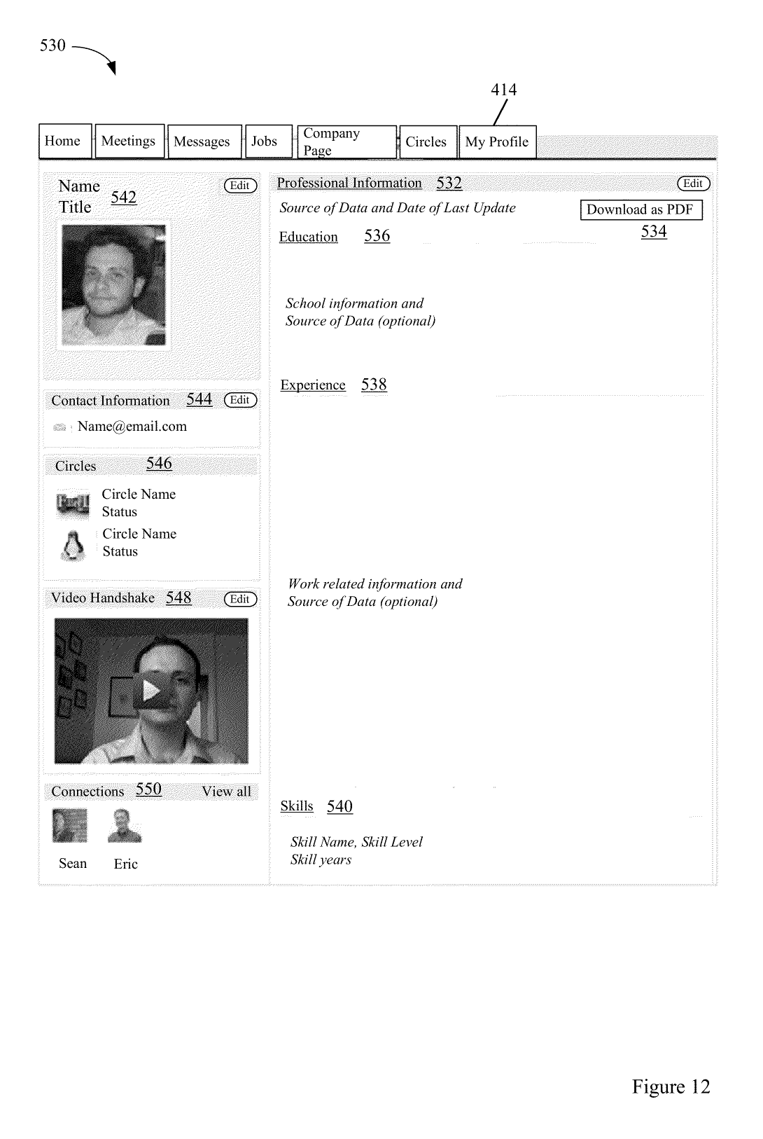

In 312, an interface for modifying a company page can be generated. The company page includes company information and may be accessible to all members. Via the interface, an administrator can add and edit a welcome message associated with the company. The welcome message can include text and/or video components. Via the interface, a video component of the welcome message can be uploaded to the company page. Details of a company web page are described in more detail below with respect to FIG. 11.

In 314, a circle configuration interface can be generated. The circle configuration interface allows the private talent network to be segmented into circles. Administrators may define the circles including a name and assign an owner of the circle. The owner may be authorized to change the name of the circle, assign representatives, update settings and edit a circle page. A circle page is similar to a company page but includes information pertinent to just the circle, such as announcements that are particular for just the circle.

Each circle is a mini-network that can be branded to express the key messages related to that circle. Each circle can have 1) its own logo and tag line, 2) a document library offering information about the circle, 3) its own meetings, 4) its own video (in the video, recruiters can explain what they are looking for or have employees explain how it is to work in a given department), 5) its own message (the message can explain what joining this group is about), 6) its own announcements and discussions related to the announcements and 7) a list of job opportunities attached to that circle. These features can be configured via the interface and be displayed via a circle page. In one embodiment, the circle page can be formatted similarly to the company page shown in FIG. 11.

In particular embodiments, tags can be associated to the circle for search purposes inside a circle. Via the circle interface, tags can be specified. An example of tags can be clean energy or water management for an environmental related circle. A circle can be public (and as a result, can be seen by candidates, who then can be provided with the option to join a circle) or private (in such cases, the circle is not visible to candidates, but the circle owner can assign candidates to that circle). In the circle configuration interface, the administrator can specify whether the circle is public or private. In addition, the administrator can specify whether the assigned owner is allowed to change the privacy settings (i.e., public or private).

In one embodiment, the entire list of circles is visible to the administrator. Further, the administrator can perform searches for people and information across all of the circles. On the other hand, representatives may only be able see the circles that they own or other public circles. However, representatives may not be able to see (e.g., see members, meetings or other information associated with the circle) into private circles that they don't own. A representative may be an owner of multiple circles where the circles can be public or private circles.

Besides creating circles, an administrator can also delete circles. The deletion process may involve removing all the information that relates members of the PTN to the circle. Further, the deletion process can involve removing all of the information that is associated with the circle and updating member home pages to remove any events or announcements associated with the circle.

Next, in 316, a meeting configuration interface can be generated. The meeting configuration interface can allow administrators and representatives to create meetings. Recruiters may enjoy the assistance of a community manager or a media agency to create events destined to attract multiple candidates, either within a group discussion or a Webinar, and establish a calendar of regular events. Organizing regular events can provide benefits, such as maintaining the interest of passive candidates about the activities of a company, identifying people of special interest before there is a position available for them (smaller discussion groups may enhance this benefit), increasing membership in the PTN as interesting people tend to bring interesting people and candidates can invite their friends to events if they are exciting or thought-provoking.

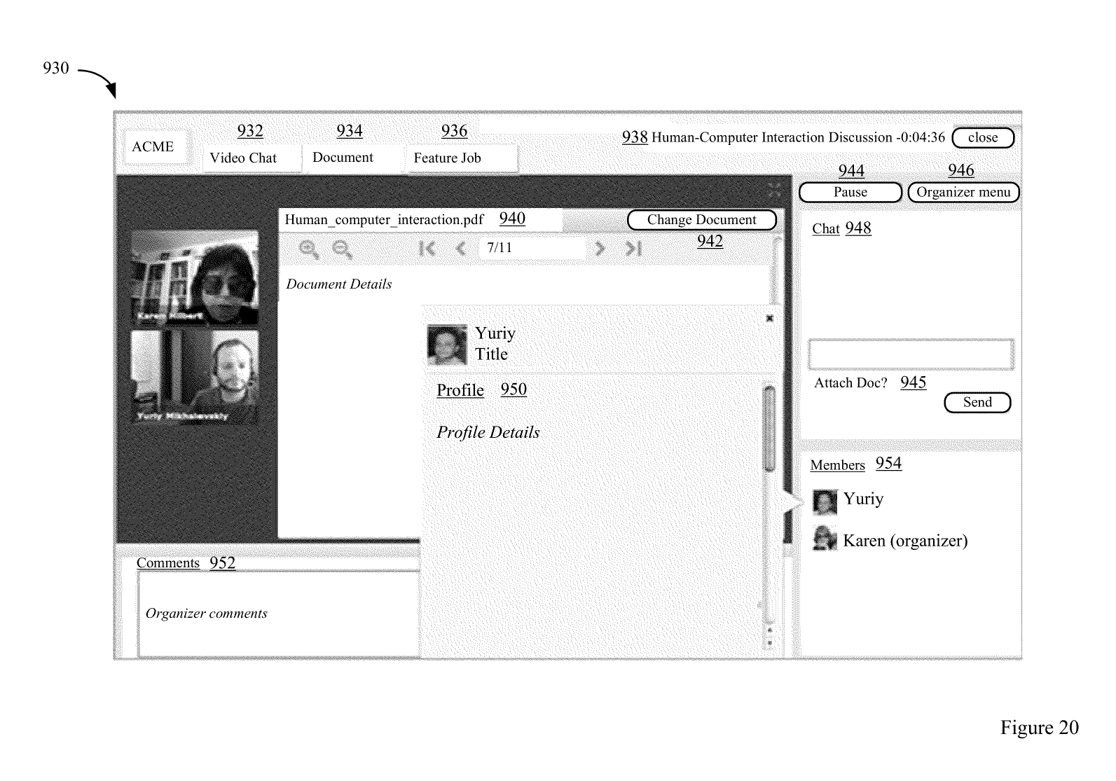

In one embodiment, scheduling a group event or a webinar is similar to scheduling a one-on-one screening or interview meeting, and can be performed through the same interface. Details of an interview meeting are described below with respect to FIGS. 19, 20 and 21. The meeting interface allows a user to enter a meeting title, specify a meeting time and then specify a meeting format, such as a video chat or a webinar and a meeting description. A meeting might be about a particular topic, such as a discussion of a skill related to a job position that is available. A webinar might be about a company employee speaking on a particular topic that is of interest to the participants.

In a video chat, every one can see everyone that is participating in the meeting. In a webinar, participants only see the host but not each other. Video-chats with one or several persons allow for full interaction between the participants. Webinars show the speakers and documents presented, but participants interact only via text chat.

When the meeting is about a job, the interface can allow a job title to be input. If desired, a document can be discussed during the meeting. The interface can allow the meeting organizer to upload the document. As described above, the document can be available for viewing during the discussion where the meeting organizer can control what portions of the document are available for viewing at a particular time. When the meeting is started, the uploaded documents will be visble inside the video booth associated with the meeting.

The interface can allow a user to limit the meeting participants. In one embodiment, the interface allows a maximum number of participants in the meeting to be specified. Thus, after the maximum has been reached, the meeting can be indicated as full. The interface allows a meeting to be broken into a number of sessions where different people can participate in each session. It may be desirable to limit the maximum number people for response time. Thus, a meeting with different sessions can extend the number of people that can participate while still maintaining the response time.

The interface can be configured to allow a user to specify that the meeting is open to everyone, open to members of one or more different circles or open only to members of the PTN that are specifically invited. For meeting where only specific members are invited, some identification information, such as the members name and/or e-mail can be entered in the interface for invitation purposes. In one embodiment, the interface may allow an individual not in the private talent network to participate in the meeting. The message may provide information about the meeting and an invite to join the private talent network if they wish to participate in the meeting. In another embodiment, even when the meeting is open to some group, such as a circle, the interface can allow a user to specify a particular person in the circle for an invitation. The invitation can bring the meeting to the particular person's attention.

When the parameters of the meeting have been specified, the system can send out invites and update different PTN pages accordingly. For example, meeting notices can be generated on the calendars of the eligible member profile pages, the company page, circle page or pages and the meeting creator's page when each of these pages are viewed. In addition, RSVP'd individuals can have the meeting invites show up as messages on their individual message page within the PTN.

Next, in 318, an e-mail campaign interface can be generated. In one embodiment, campaigns can be used in conjunction with importing candidates from an ATS (Applicant Tracking System). Upon importing the candidates, the system can send a campaign out to everyone who was just brought into the network to let them know that they can sign in, update their profile. As another example, a campaign can be generated for a webinar where people not currently members of the PTN or members of the PTN can be invited. In yet another example, a job description can be generated with an attached questionnaire where the invited individuals can be invited to respond to the questionnaire as well as to join the PTN.

The email campaign interface can allow a staff member, such as a member with administrative privileges to create a campaign, specify a name and description of the campaign, specify and attach content to the campaign (e.g., a job description and questionnaire), specify recipients of the campaign and send out the campaign. In addition, the interface may allow a user to specify a length of the campaign after which the campaign may end. Also, the interface can be configured to generate reports associated with the campaign. For example, a report may include information related to what percentage of individuals responded to the campaign by joining the PTN. If an event was included in the campaign, the report can specify what percentage of the campaign recipients participated in the events. The reports can be generated for on-going campaigns and previously implemented campaigns. Other analytics, such as characteristics of individuals that responded or didn't respond to the campaign can also be generated.

Next, one example of an interface configuration page for branding a PTN is described with respect to FIG. 7. Then, examples of PTN pages configured using the PTN creation interface are discussed with respect to FIGS. 8-14. FIG. 7 is a screen shot of a PTN page 332 for branding a private talent network.

The logo and branding page 332 can be part of a tabbed interface system that allows a user with sufficient privileges to access different administrative functions by selecting different tabs. In FIG. 7, the logo and branding tab 336 is selected. The registration page tab 338 when selected causes an interface page to be generated for configuring the welcome page described above in step 308 of FIG. 6. A selection of the staff manager tab 340 causes an interface page to be generated for adding/deleting staff members of the PTN and setting privileges described in step 306.

Continuing, A selection of the circles manager tab 342 causes an interface page to be generated for configuring circles including adding new circles described above in step 314. A selection of the e-mail campaigns tab 344 causes an interface page to be generated for creating email campaigns described above in step 318. A selection of the meetings tab 346 causes an interface page to be generated for creating meetings described above with respect to step 316. A selection of the network settings tab causes an interface page to be generated for configuring the PTN described above with respect to step 304.

Via the logo and branding page 332, a logo 350 can be uploaded 354 in a number of different formats. A selection of the clear image button 352 causes the uploaded logo 350 to be cleared. The uploaded logo can be displayed on a number of different pages in the PTN, such as the welcome page 370 in FIG. 8 or the company page 500 in FIG. 11.

The main navigation color 356 portion of the page allows a user to select the color of menus within the network. Via button 358, a custom color can be selected. Once the logo and colors are selected, the user can save 360 the selections or cancel the selections 362.

Next, an example of a welcome page configured via the registration interface page (e.g., see step 308 in FIG. 6 and registration page tab 338 in FIG. 7) is described. FIG. 8 is a screen shot 370 of a configured welcome page in a PTN. The logo 372 which can be user specified and is placed at the top of the page. In some instances, the welcome page can be linked to web-pages hosted outside of the PTN. In one embodiment, jobs available at a company associated with the PTN can be displayed on this page. However, this option is not activated in this example and no jobs are shown.

A talent network description 384, which can be user-specified by a staff member with the required privileges, is placed at the bottom left corner. A video message 386, which can be activated by a user selection and is typically about two to three minutes long, is placed on a right side of the page. The description 384 and the welcome message 386 can encourage a visitor to register with the PTN.

The registration section 374 provides a number of different mechanisms for allowing an individual to join the PTN. For instance, the member can join via an existing social media account, such as LinkedIn 376 or Facebook 378 or any other social network or web page. As described above with respect to FIG. 5A, when a user registers via their social media account, the system can be configured to import data from their social media account which is used for filling out a user profile within the PTN. As also described above with respect to FIG. 5A, a user doesn't need to register using a social media account and can manually provide the information needed to register. This option can be initiated via selecting the register button 380. When a member of the PTN that has previously registered arrives at this page, a selection of the login link 382 can cause the system to generate a login page that allows the user to provide their login information.

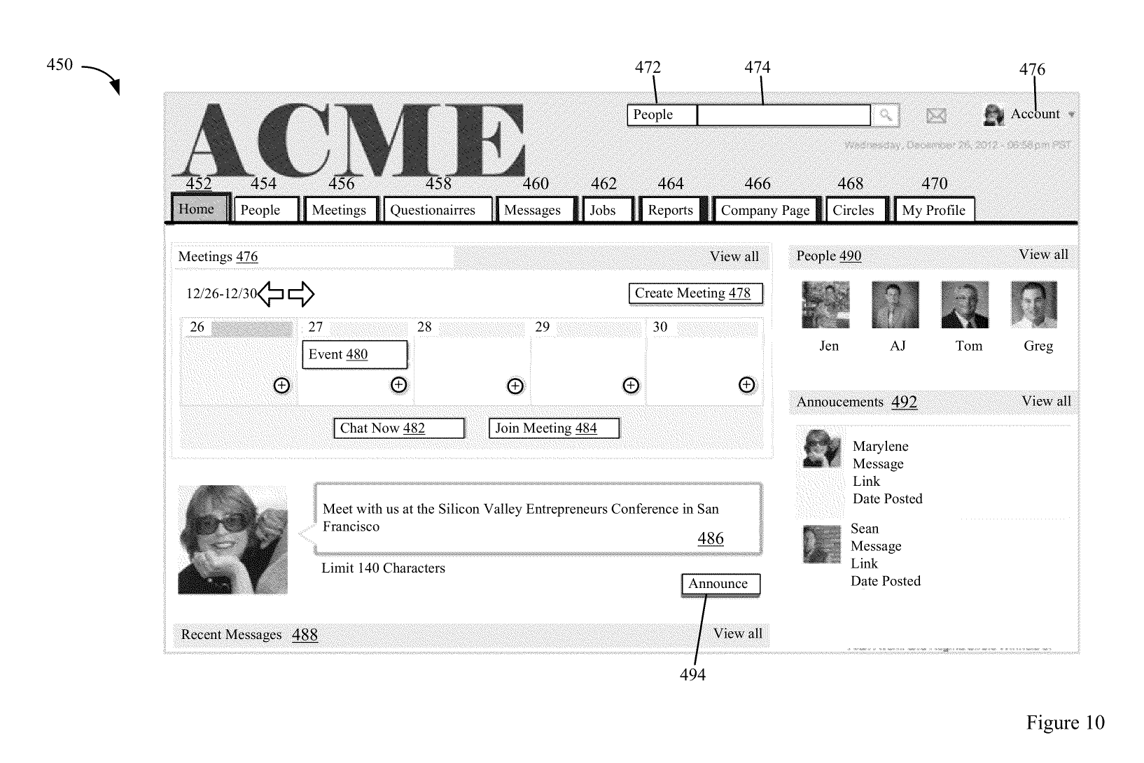

Registered members of the PTN can be provided a home page. The home page may be the first page the system displays after a member logs into the PTN. Next, details of an example home page are discussed with respect to FIG. 9.

FIG. 9 is a screen shot of a candidate home page 400 in a PTN. The user interface 400 includes a number of tabs, home 402, meetings 404, messages 406, jobs 408, a company page tab 410, a circles tab and a my profile tab 414. The home tab 402 when selected can cause page 400 to be displayed. A selection of the meetings tab 404 can cause a page where details of meeting accessible to a PTN member can be displayed. A selection of the messages tab 406 can cause an interface that allows a member to view messages received from other PTN members including staff members, respond to messages and to send new messages.

A selection of a jobs tab 408 can cause an interface that allows a member to view and search for available jobs posted within the PTN. The member can select various jobs of interest to be saved by the system and these can be viewed when this tab is selected. The company page 410 is a page that includes details of a company or companies associated with the PTN. An example of a company page is described with respect to FIG. 11.

A selection of a circles page 412 causes a drop down menu to be generated that allows a user to select various circle pages for display to which the member belongs. In addition, circles that are available for the user to join can also be displayed. The format of a circle page can be similar to the company page in FIG. 11. However, as described above, the circle page can be separately branded and include messages, announcements, discussions, events and documents that are only associated with the particular circle.

A discussion can be on a topic of interest to participants. During the discussion, video and text, such as text chat, can be recorded. The system can be configured to allow members to subsequently re-watch the discussion. If the discussion is private only staff members (e.g., recruiters or hiring managers) may be allowed to re-watch the discussion. When the discussion public, circle members or other general PTN members may be able to re-watch the discussion.

Further, links to discussions of general interest can be posted to outside sites, such as social media sites or included in e-mails, such as part of an e-mail campaign. When a person is interested enough in the discussion to select the link, the person can be encouraged to join a PTN associated with the link. Within the PTN 80, discussions can be archived and searchable to allow for future viewing and data mining.

A selection of the My Profile tab 414 causes a page including details of a user's profile in the PTN to be generated. Via this page, a user can add additional profile details and/or edit information that has been previously entered. As described above, in one embodiment, information on this page can be received from a social media site separate from the PTN on which the user maintains a separate social media profile. The system can be configured to check the social media profile for new information and update the user's profile in the PTN at regular intervals.

The upcoming meetings section 416 can show meetings that are available to a user or which a user has elected to participate. On page 400, five days 420 are shown. For these five days, no meetings are available. To participate in a meeting, the user can select the meeting and then select the join meeting button 418.

The profile section 422 can display a few details of a PTN member's profile. Additional details are displayed by selecting the my profile tab 414. The recent message section 424 can display a few of a member's most recent messages. No new messages are displayed. A user can view additional messages by selecting the messages tab 406.

An announcements section 426 displays announcements that may be of interest to the user. The announcements a user receives can depend on the circle or circles to which they belong. Three more recent announcements are shown in the section.

A section 428 for inviting their friends to join the PTN is provided. Within the section, a user can specify a number of emails or other contact information. When the emails are specified and the invite button 430 is selected, email messages can be generated and sent to the specified addresses. The email can include information about the PTN, the person that invited them and a link to a registration page for the PTN.

In one embodiment, rewards can be provided to individuals that draw people to the PTN. For example, after a user invites a number of people to the PTN which ultimately join, the user can be made of a member of a circle that includes VIP events only available to members of the circle. In another example, a user can earn points for each new member that they attract. The points can be redeemed for awards. An awards circle page can be provided where the user can redeem their points. In yet another example, when an individual invites a friend to the PTN, the friend becomes a member of the PTN and then the friend subsequently is hired by the company. The individual can receive points or an award, such as a referral fee, for initially referring the person.

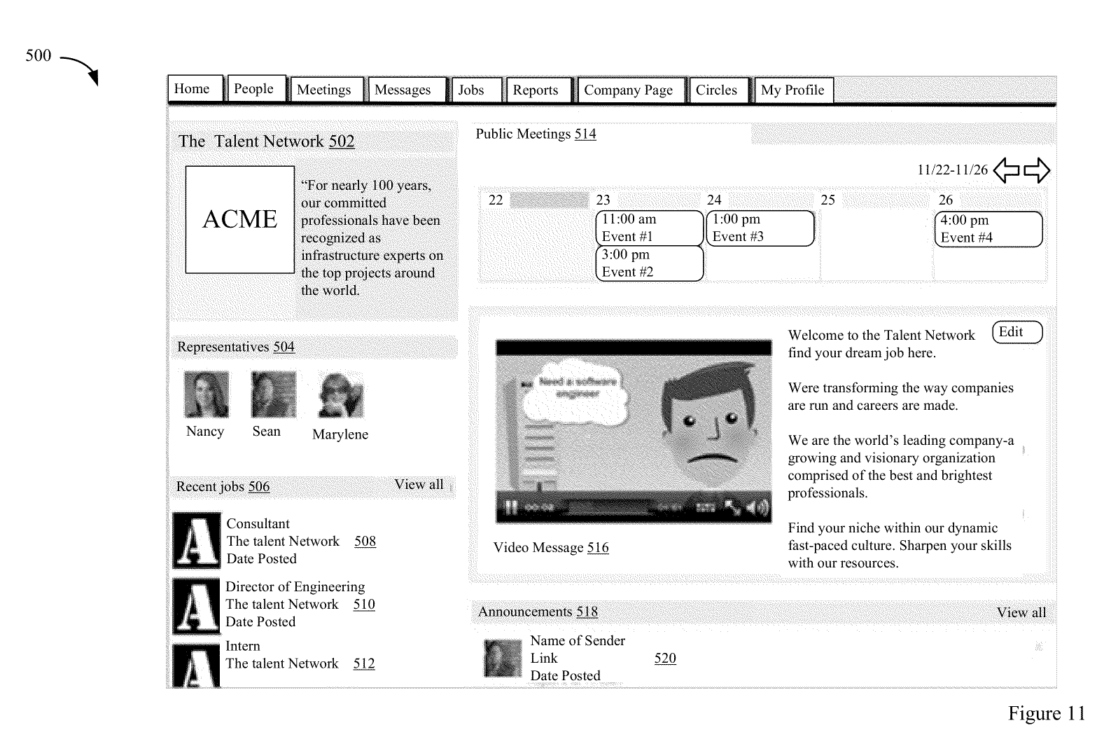

Next, details of a staff member's home page 450, which can be a recruiter in the PTN, are discussed. FIG. 10 is a screen shot of a recruiter home page 452 in a PTN. The page 450 includes a home tab 452, a people tab 454, a meetings tab 456, a questionnaire tab 458, a messages tab 460, a jobs tab 462, a reports tab 464, a company page tab 466, a circles tab 468 and a my profile tab 470. A selection of the people tab 454 causes an interface page that allows a staff member to search for people, such as search for people to fill a particular job position (e.g., see FIG. 14). The people page can include information about searches that the staff member has previously made and lists of people currently of interest to the staff member.

The meetings tab 456 can include details of meetings that a staff member has created or which the staff member plans to attend. A selection of the questionnaire page can cause interface pages to be generated that allow a staff member to create a questionnaire, view an active questionnaire that has been sent out and see responses to the questionnaire. Details of questionnaires are described below with respect to FIGS. 15, 16, 17, 18A and 18B. A selection of the messages tab 460 can cause an interface page to be generated that allows the staff members to send, receive or create new messages.

A selection of the jobs page 462 can cause an interface page to be generated which allows a staff member to post a new job description and view job descriptions for which they are recruiting. A selection of a reports tab 464 can cause a page that allows the member to generate reports about their activities and possible other staff members activities if they are a team leader. For example, a report can be generated about how many individuals that they have contacted for a particular job position, whether the contacted individuals have responded to a questionnaire associated with the job position, whether they have reviewed the questionnaire responses and whether they have scheduled follow up meetings, such as with a hiring manager.

A selection of the company page tab 466 can cause the company page to be displayed. If the staff member has sufficient privileges, the company page that is displayed may allow the member to modify the page. A selection of the circles tab 468 can cause a drop down menu that allows the member to select from among circles to which they belong. If the staff member has sufficient privileges they may be able to modify the circle in some manner, such as add/delete a member from the circle, generate a meeting associated with the circle or generate an announcement associated with the circle. A selection of the profile tab 470 can cause a page with details of the members profile to be generated. In one embodiment, via the profile page, the member can cause their profile to be visible or not visible to other members of the PTN.

The staff member home page 450 includes a search interface 472 that allows the staff member to search for people in the PTN. An entry box 474 is provided for entering search terms for the people search. The account button 476 can be selected to allow a staff member to view and modify details of their account. The meetings section 476 allows a staff member to view events, such as event 480, create a meeting 478, join 484 a meeting in progress or chat 482 with an individual or a group of individuals. The chat 482 can be a video, text, or audio chat.

The page 450 allows a staff member to generate an announcement. In one embodiment, a text message can be entered in box 486 for the announcement. When the announce button 494 is selected, the announcement or discussion topic can be posted. The announcements 492 can display announcements they have created or received from others, such as other staff members.

The recent messages section 488 allows the staff member to see recent messages they have received. The people section 490 can display people of interest to the staff member. For example, people of interest can be individuals that the staff member has targeted for a particular job position.

Next, a sample company page is described. FIG. 11 is a screen shot of a company page 500 for a PTN. A talent network section 502 is included on the page. The section includes a company logo and a description of the talent network. A representative section 504 includes pictures and names of representatives within the PTN. As described above, in one embodiment, the representatives can be recruiters for a company associated with the PTN.

A recent jobs section 506 includes job positions associated with the company that have been recently posted. A first job 508 is for a consultant, a second job 510 is for a director of engineering and a third job 512 is for an intern. By selecting the job, a user can learn additional details about the job, such as via a job description.

A public meeting section 514 shows events that are open to everyone in the PTN. Four events on different days are posted on a calendar. A message section includes a video message 516 and a message in a text format about the company. If the user is a staff member and has sufficient privileges, the user can modify this page including uploading a video message and changing the text message. The announcements section 518 includes general announcements, such as 520. Each announcement in this example includes a name of a sender, a selectable link that allows more details about the announcement to be obtained and a date posted.

The company page 500 is essentially a circle page that includes everyone. Circle pages can be formatted similarly to company pages. However, the circles can be individually branded. For instance, in section 502, a different logo and a different message can be presented. Further, the video message 516 can be different. The circle can have people, jobs, meetings, announcements and a document that are particular to only to the circle. Only members of a circle will have access to the circle from their home page. As described above, the circle page can be displayed when it is selected from a drop menu or some other selection mechanism associated with the circle tab.

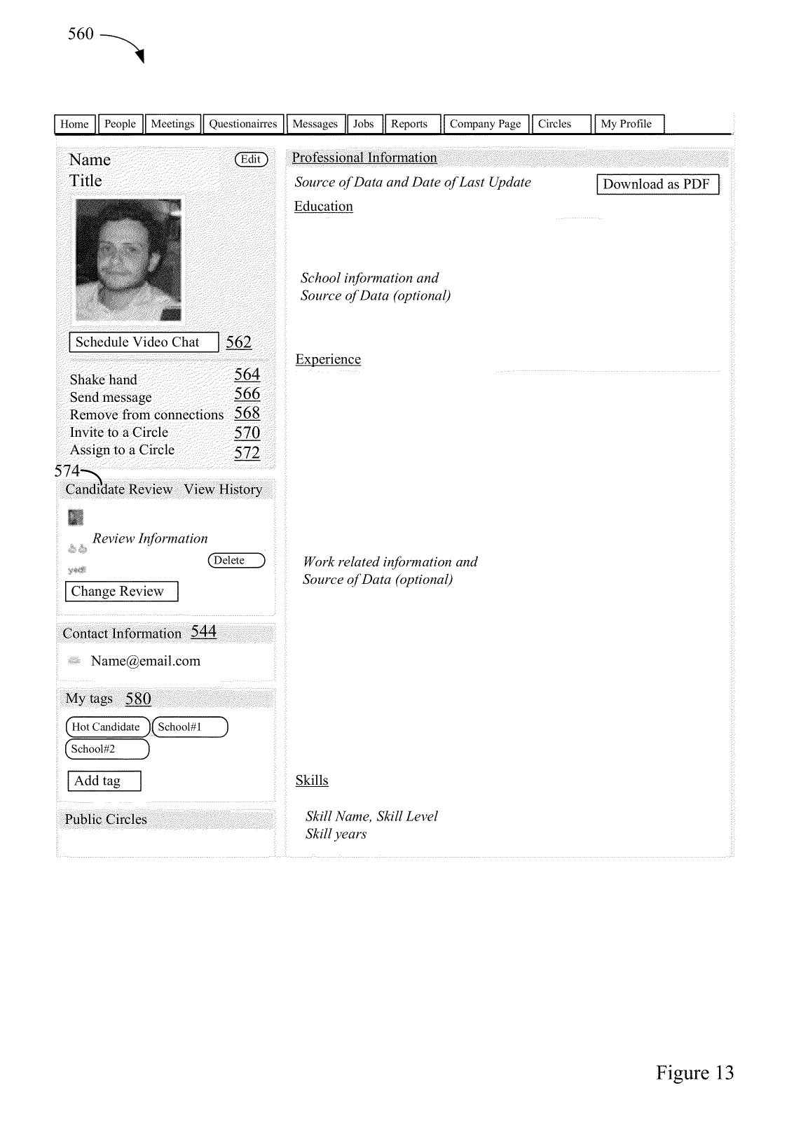

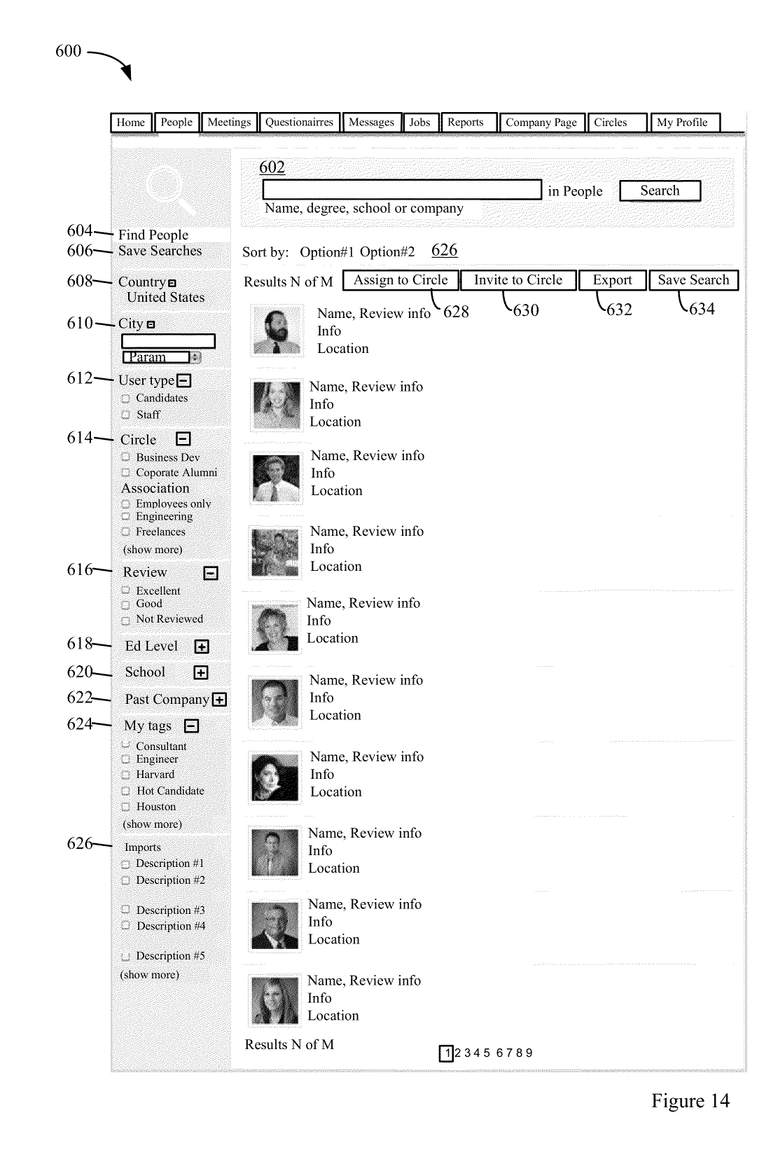

Next details of a member's profile page are displayed. In one embodiment, as is discussed with respect to FIGS. 12 and 13, a PTN member's profile page can appear different when viewed by the member as opposed to a staff member. In FIG. 12, the view presented to a non-staff member is shown. In FIG. 13, the view presented to a staff member is shown.

FIG. 12 is a screen shot of a candidate (member) profile page 530 in a PTN when viewed by the owner of the page. Since it is being viewed by the owner of the page, details of the page can be edited. A selection of the profile page tab 414 can cause the system to generate the profile page 530 after the member has logged into the PTN. On the page, a first section 542 including a name, title and image, a second section 544 including contact information (e.g., e-mail address, phone number, physical address, etc.), a third section circles 546 to which the member belongs, a fourth section 548 including a video handshake, a fifth section 550 including connections, a sixth section 536 including professional information, a seventh section 538 including employment experience and eighth section 540 including skills are displayed.

The video handshake 548 can be an introductory message uploaded by the member. The connections 550 can list individuals to which the member is connected in the PTN. The connections can include staff and non-staff members of the PTN. The professional information 532 can indicate a source of data and when it was last updated. For example, the data may have been entered by the member manually or may have been obtained from a social media account outside the PTN linked to the PTN.

The education information can include schools the individual attended and optionally a source of the information. The experience information can include job related experience, such as places of employment, and optionally a source of the data (e.g., social media site to which the account is linked, resume data from the ATS or input by the candidate). The skill information can include a description of the skill including but not limited a skill name, a skill level and skill years.

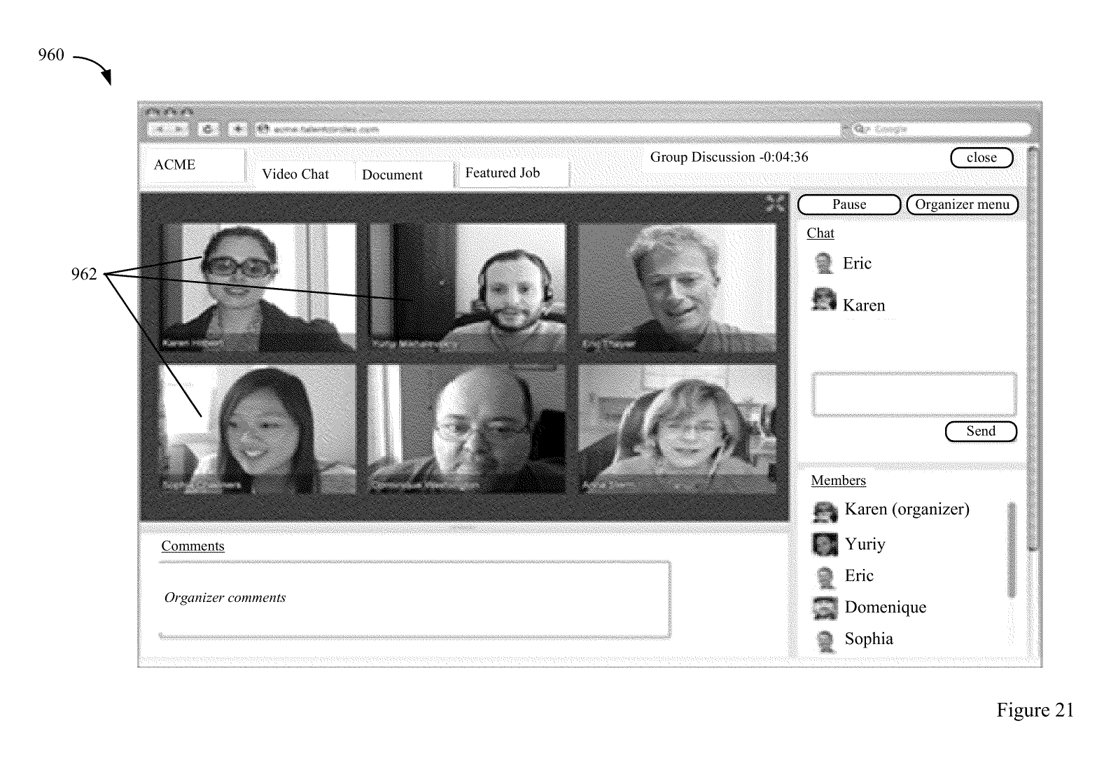

Next, a format of a PTN member profile page, such as a job candidate, when viewed by a staff member is described. FIG. 13 is a screen shot 560 of a candidate profile page as viewed by a recruiter in a PTN. The page 560 includes a button for scheduling a video chat 562. Details of a video chat are described below with respect to FIGS. 20 and 21. Via the staff member view, a staff member can electronically shake hands 564 with the person, send a message 566 to the person, remove the person from connections 568 (typically, the staff member's connection), invite the person to join a circle 570 and assign the person to a circle 572.

A candidate review section 574 that is only visible to staff members, such as recruiters, is displayed on the page. The section 574 can include information about reviews and other interactions that have been generated within the PTN. In one embodiment, a staff member can delete or change review that has been generated about the individual.

The tags section 580 can display tags that have been associated with the person. In one embodiment, staff members can add tags to individual profiles. The section includes a button for adding tags. The tags can be used when searches are performed by the staff members. For example, if a staff member has added the tag “hot candidate,” a tag “first school” or a tag “second school” to the candidate's profile, when the staff member performs a search including one or more of the tags, this person will show up in the search.

In one embodiment, the tags that are added can be staff member specific. Thus, when a first staff member views the profile page, only tags that the first staff member has added for the individual will be visible but not tags added by other staff members. When a second staff member views the tags, then only tags the second staff member has added will be visible and not the tags added by the first staff member. If the first and second staff members are part of a group and the system allows group tags to be added, then the system can show only tags added by members of the group and the group tags will be visible when the first or the second staff members view the profile but not tags by staff members outside the group. In yet another embodiment, some tags can be visible to any staff member once the tag has been added.

FIG. 14 is a screen shot of a search page 600 for a recruiter in a PTN. In the search section 602, a person can enter search parameters and select the search button to initiate a search. A selection of the save searches tab 606 can generate an interface page that allows the recruiter to view previously saved searches. To return to the current page from the saved searches page, the recruiter can select the find people tab. To save the current search, the recruiter can select the save search button 634.

In the left column of the page, the recruiter can specify a number of search parameters. In 608, the recruiter can select a country of the search, i.e., for people located in a particular country. In 610, the recruiter can specify a city on which to base a search. An additional parameter, such as a distance from the city, can be selected to limit the search. When this parameter is selected, the search engine can search for all people within the selected distance from the input city. In 612, the recruiter can select a parameter that allows a search among candidates (members of the PTN) or staff.

In 614, a recruiter can select from among circles or associations to limit searches, such as from among a business development circle, a corporate alumni circle or both. As another example, the recruiter can select one or more of a current employee only association, an engineering association or a freelance association to limit a search. In 616, the recruiter can select a rating parameter associated with a review to limit a search. For example, the recruiter may wish to only see people with an excellent or good review or only people that have not been reviewed yet.

In 624, the recruiter can select a search to be limited based upon on their tags, such as consultant (i.e., position), engineer (i.e., position), Harvard (i.e., school), Hot candidate (i.e., rating), Houston (i.e., location) or Programming (i.e., skill). As described with respect to FIG. 13, staff members can tag PTN members where the tags are only visible to the staff and not the non-staff PTN members.

In 618, the recruiter can select an education level to limit a search. In 620, a recruiter can select from among one or more schools to limit a search, such as Ivy League schools or Stanford University. In 622, the recruiter can select one or more companies at which a person was previously employed to limit a search, such as Google, Apple or Facebook. The import section 626 allows a recruiter to specify candidates that were imported into to the system to limit a search, such as candidates that participated in a particular event or candidates imported from an external database.

Once a search is implemented, the interface provides options 626 for sorting. For example, people returned in the search can be sorted according to their relevance to the search criteria or can be sorted according to location specified in their profile. A list of people including some information about each person, such as their name, review information, profile information and location, can be presented. The list can span multiple pages.

A selection of one of their individuals can cause their full profile to be displayed. In one embodiment, the interface can switch to the selected person's profile page. In another embodiment, the person's profile can be displayed in a pop-up window. When one or more people from the list are selected, a selection of the assign to circle button can cause the individuals to be assigned to a particular circle that has been specified. When the assigned individual or individuals log into the system, the specified circle to which they have been assigned can appear when the circle tab is selected.

A selection of the invite to circle button can cause one or more selected individuals to be invited to a circle. When the invited individuals log into the system, a message can appear that indicates they have been invited to join the circle. The message can include a link that when selected allows the invited individual to join the circle. A selection of the export 632 button can cause the system to export information about one or more individuals that appeared in a search to an external file.

### Communication Methods in a Private Talent Network

Next, methods of communicating with candidates involving pre-interview questionnaires or video interviews are described. A method including generating and receiving results from a questionnaire is described with respect to FIGS. 15, 16, 17, 18A and 18B. The questionnaire can be used as part of a pre-interview screen methodology. A method associated with creating and participating in a video interview is described with respect to FIGS. 19, 20 and 21.

FIG. 15 is a flow chart of a method 700 for interviewing using a questionnaire in a private talent network in accordance with the described embodiments. In the method, pre-recorded screening and interviewing questionnaires can be generated and sent by companies to as many candidates as they deem necessary to develop a sufficient talent pool for a job. Based upon the questionnaires recruiters can test and grade the skill set of candidates, such as via text or multiple choice responses and evaluate their cultural fit, such as via a rating of their video responses. Pre-recorded screening and interviewing questionnaires can be addressed to candidates both inside and outside the PTN. The questionnaires enable a company to check on a very large number of candidates quickly. This methodology can be more objective than simply filtering out candidates via the keywords that appear in their resumes.

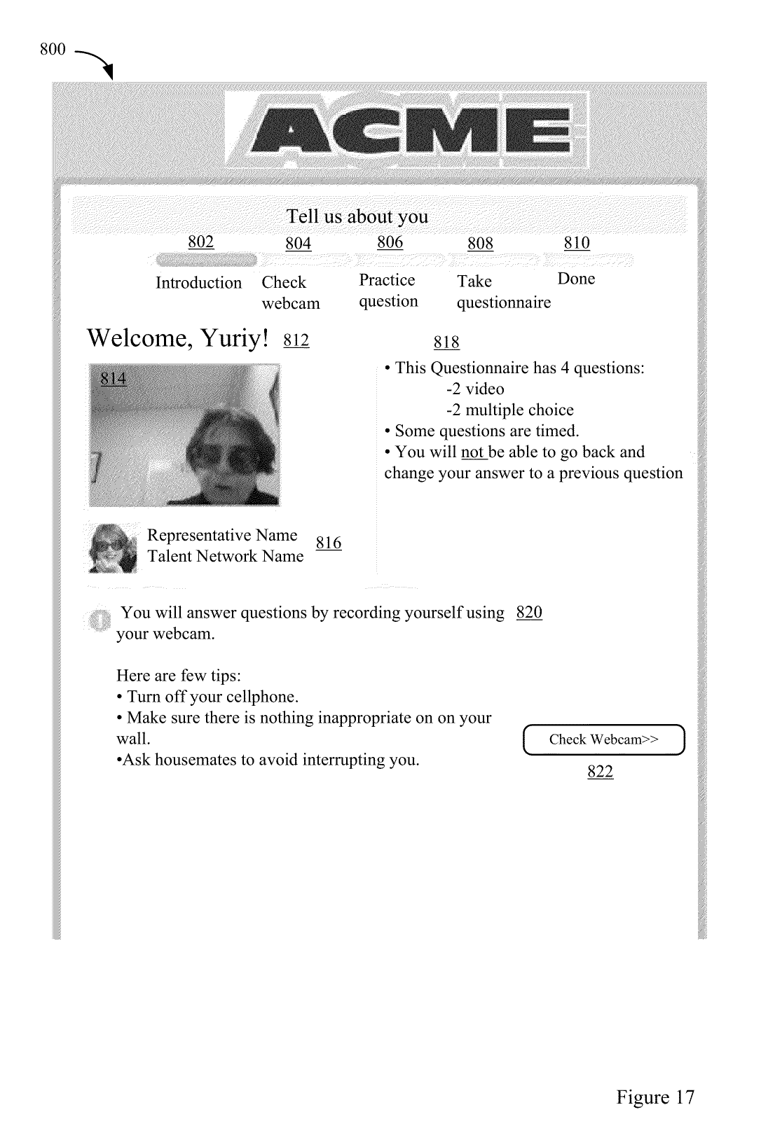

Next, details of the methodology are described. In 702, a questionnaire template can be selected for use in creating a questionnaire. The system can be configured to generate a questionnaires menu that allows a user to create questionnaires from scratch or using templates. A new questionnaire can be created by mixing questions from one or more saved templates and from custom questions that are added as the questionnaire is created. The system can store questionnaires as templates after they are created for later reuse by other system users. An example of one page of a questionnaire creation interface is described below with respect to FIG. 16.

In particular embodiments, lists of templates can be grouped according to the type of candidates to be screened. For example, while some general questions apply to any type of candidate, other questions are clearly targeted at a specific skill-set or a specific job, such as engineering questions for engineers or programming questions for programmers. When templates are selected, the interface can allow a user to view templates from particular groups and then select one as starting basis. The system is configured to allow a user to select questions from different templates and add them to the questionnaire that is currently being created.

The templates can be personal or can be shared across the recruiting team. For example, an individual can create a personal template that is only visible to the individual as well as anyone with administrative privileges. In other example, a template can be visible to all members of a recruiting team. For example, a circle can be created for a recruiting team where templates are placed in the circle and visible to the circle members.

The system can include a feature that allows questions to be submitted for review. The review can be performed to assure that the questions comply with various hiring laws to which the company is subject. When a new question is created, the system may require that the question is submitted for review and approved before it can be saved as part of template or used in questionnaires. After it is approved, the question can be saved as part of a template and subsequently reused as part of a questionnaire without additional approval.

Next, in 704, via the questionnaire menu, a user can add a question via a selection of an “add a question” button on the interface. Then, via the interface a user can select a format for the answer. For example, the format can be but is not limited to a video answer, a text answer, a verbal (audio only) answer, multiple choice with one correct answer, multiple choice with multiple answers or true/false. One questionnaire may use many question types.

As described above, a video question can be selected that calls for a video answer from the individual taking the questionnaire. The answer can be recorded and subsequently reviewed and scored. If the response will be scored, a scoring range can be indicated including a maximum score, such as between 1 and 100 where the 100 is a maximum score. A hint or hints associated with the question can be input. The system can output the hints when the questionnaire is taken. How much time is allotted to answer the question can be specified. In one embodiment, the individual can be allowed to re-record their response. For example, no re-record, one, two or three records can be allowed. In one embodiment, only the last recording is submitted for grading purposes.

In order to facilitate the work of the reviewers who will assign the score, the system allows scoring guidelines, which will not be seen by candidates, to be specified. In one embodiment, the guidelines for grading the question can be entered via a text box in the interface. In another embodiment, the system can allow a document including the grading guidelines to be uploaded. The guidelines for grading a question can be stored as part of a template and can be modified if desired when the questionnaire is created.

For text questions, multiple choice with one answer questions and multiple choice with multiple answers questions, the system can allow a user to specify a time limit for the question and one or more hints. For text (e.g., essay questions), a scoring range can be specified and guidelines for scoring the questions can be provided. For multiple choice with one answer a score can be specified for each correct/incorrect answer. For multiple choice with multiple answers, scores can be specified for each correct/incorrect answer.

In one embodiment, the system can be configured to randomly select from a pool of questions. For example, a pool of multiple choice answers can be selected that are considered to be of a similar difficulty. When the questionnaire is implemented, the system can select one of the questions from the pool to present to the candidate.

Besides selecting the questions as part of creating a questionnaire, a recruiter can name the questionnaire and specify a job associated with the questionnaire. The questionnaire can include a link that allows the individual taking the questionnaire to learn more details about the job. Also, a link can be provided that allows the recipient of the questionnaire to register with a PTN if they have not already done so. The interface allows a user to specify a deadline for responding to the questionnaire. After the deadline expires, the questionnaire is closed. A deadline doesn't have to be selected.

The interface is configured to allow a user to indicate if the questionnaire is public or private. If the questionnaire is private, only the candidates that are invited can take it. If it is public, the questionnaire can be shared. For example, a first recipient of the questionnaire can mail a link to the questionnaire to a second recipient where both the first and second recipient can take the questionnaire.

In one embodiment, a welcome message can be associated with the questionnaire. The welcome message can be provided in different formats. For example, a recruiter can record a video welcome message that is played before the person takes the questionnaire. In another example, a recruiter can enter a text message that can be viewed before the person takes the questionnaire. When the questionnaire is determined to be complete, a user can review it and save it.

Next, in 706, a questionnaire can be opened by selecting “Open Questionnaire” in the dialog box. By doing so, the user confirms that they are aware that the questionnaire can't be changed any longer, because this is the version that will be sent to all the candidates that have been specified. The system allows a user to close a questionnaire at any time including before a deadline for the questionnaire has been reached. When a questionnaire is closed, recipients are no long allowed to take it. In one embodiment, the system can be configured to allow a user to specify a maximum number of users that can take the questionnaire. When the limit is reached, the system can be configured to close the questionnaire.

In 708, via the interface, the creator of the questionnaire can indicate invitees. If the questionnaire is private, each recipient is specified. For example, an email address of each recipient can be specified. If the questionnaire is public, the creator and recipients can forward the questionnaire to selected recipients. As examples, candidates can be invited by their names in the PTN, via e-mail addresses and via membership in a circle of the PTN. The recipients don't have to members of the PTN on which the questionnaire is created.

Public questionnaires can be posted on social media sites, such as LinkedIn, Facebook, Twitter and Google+ as well as any site or document using the URL. In addition, the questionnaire can be attached to job descriptions which are posted to job sites. When a recipient decides to take a questionnaire, the recipient can be requested to login into a PTN associated with the questionnaire. The login process may require the recipient to register with the PTN and become a member of the PTN. After logging in, the recipient's profile information can be updated or newly added to the PTN.

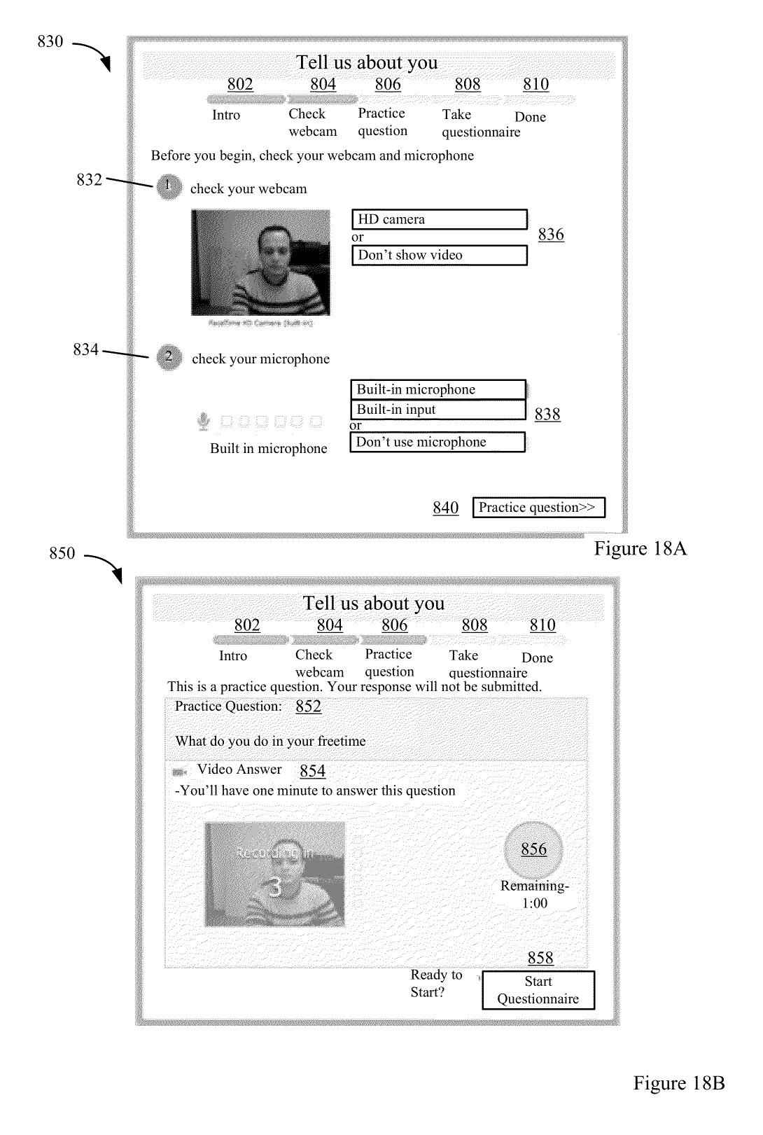

In 710, a recipient can receive a message with a link that enables them to participate in the questionnaire. When the link is selected, a connection can be established with a PTN. In 712, a welcome page can be generated. An example of a welcome page is described with respect to FIG. 17. The welcome page can include one or more of a description of the questionnaire, such as number of questions and rules for taking the questionnaire, a welcome message and a job description. If the welcome message is in a video format, then the recipient can click on the video to see a playback of the message.

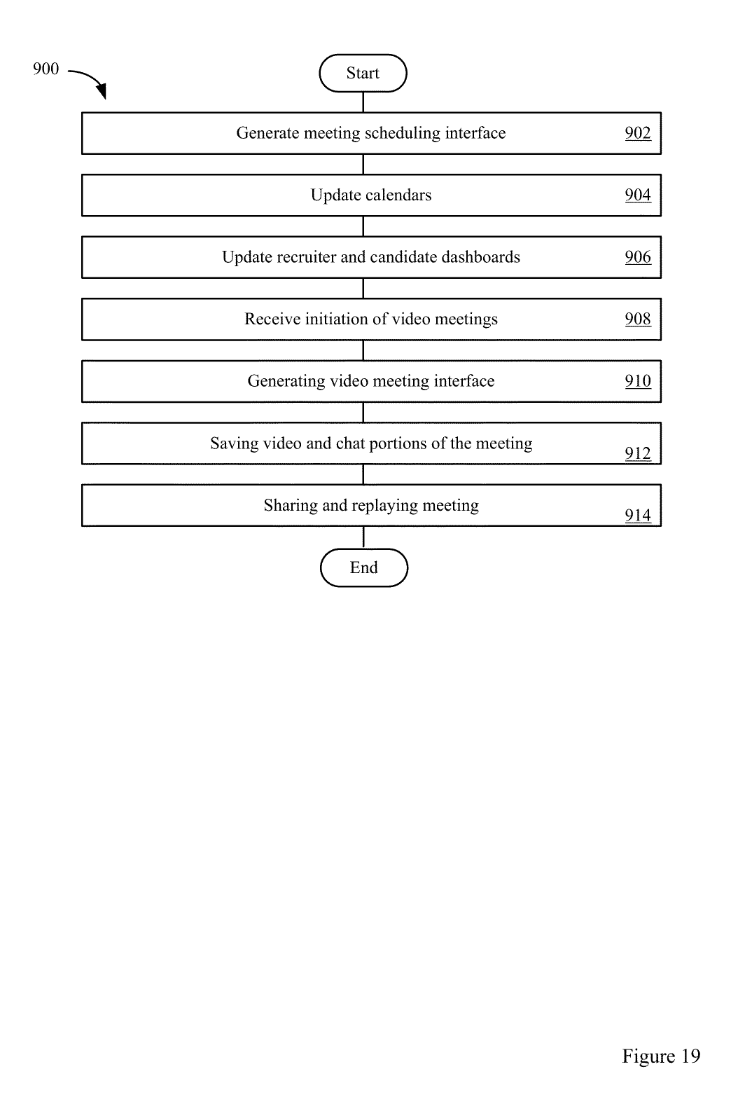

In 714, the user can be requested to check operation of their remote interface (See FIG. 18A). For example, if some of the questions are to be recorded as video answers, the recipient can check to see if their recording apparatus is working properly with the system by recording and then playing back a message through the system. In one embodiment, the recipient can take a practice question which can confirm proper operation of their system (see FIG. 18B).

In 716, the system can output questions and record responses from a recipient. In 718, when the recipient has completed all of the questions, the system can output a thank you message. The thank you message can be recorded by the recruiter or entered into the system in a textual format. The participant can be asked to login into the PTN using a social media account and complete a profile. As described above, when a participant logs into the PTN via their social media account, the system can automatically populate the participant's profile from the retrieved social media account information.

As described above with respect to FIG. 10, a recruiter profile page can include a tab 458 called questionnaires. When this tab is selected, the recruiter can view questionnaires that have been previously created and templates for questionnaires. On the questionnaire page, a title, a description and status of each questionnaire is shown. If the questionnaire is open for responses, the status can be indicated as open. If the questionnaire is closed for responses, the status can be indicated as closed. If a questionnaire is in the process of being created but has not yet been opened it can be marked as pending. As recipients respond to each questionnaire the total number of responses can be displayed next to the description of each questionnaire.

The people in charge of analyzing the responses are called reviewers. These reviewers can be any person selected by the recruiting team and include any personnel the team deems appropriate to perform these reviews. In 720, via the questionnaire interface, a user can select reviewers to review certain responses and send a message to the reviewers. In addition, the interface includes a separate text box for sending a message to all of the reviewers for a particular questionnaire, such as time limit in which to perform the reviews.

In 722, the reviewers can generate feedback information about the question answers that are reviewed. The feedback information can be related to the content of answer of the question as well as to intangibles, such as how the person presents themselves while answering the question. The feedback information can be stored in the system. Subsequently, the feedback can be viewed by other staff members but not the candidates.

In 724, the system can generate reports. Some examples of report information that can be generated include but are not limited to 1) total scores for each participant where the candidates can be sorted according to score and 2) question stats, such as high, low and average scores for each question and a number of answer submitted. Further reports on reviewer activity can be generated. For example, the system allows a team manager to view a status team member's reviews, such as a total number of reviews performed, a breakdown of the total reviews performed according to team members and when the team member last reviewed a question. The report data can be exported from the system, such as in a comma separated format for viewing in a spread sheet.

Next with respect to FIGS. 16, 17, 18A and 18B, some example questionnaire interface pages are described. FIG. 16 is a screen shot 750 of a questionnaire configuration page in a PTN. A selection of the “my questionnaires” button 754 allows a staff member, such as a recruiter, to view the questionnaires to which they have access, such as the questionnaires they have created. Details of one such questionnaire are displayed on the page. A selection of the templates button 756 causes a list of templates to which the member has access to be displayed. As described above, the templates can be used to start a new questionnaire and questions from any of the available templates can be imported into a questionnaire that is being created.

In FIG. 16, the questionnaire info tab 758 is selected which causes the system to generate information about the selected questionnaire. The status 770 of the questionnaire is open. Thus, recipients can still respond to the questionnaire if they have not already done so. A selection of the close questionnaire button 766 can cause the questionnaire to be closed so that no more recipients can respond. A selection of the invite candidates button 768 can cause an interface that allows the recruiter to initial invite recipients or invite additional recipients after the questionnaire has opened. The recruiter can continue to invite recipients while the questionnaire remains open.

The name 772 of the questionnaire is “Tell us about you.” The link 774 at which the questionnaire can be taken is “https://acme.com/questionnaire.php.” The type of questionnaire is public. Thus, anyone is allowed to take the questionnaire. In addition, candidates can forward the questionnaire to their friends. The feature job 776 associated with the questionnaire is strategic partner development. A deadline 778 for responding to questionnaire has been specified. The recruiter can modify these features, such as the title or whether it is public or not via the interface.

A welcome message 780 in a video format has been uploaded. The recruiter can select the video message for playback if desired. The closing message 782 has been specified in a textual format. A response status box 784 provides some information about the responses, such as a number of people that have responded. A selection of the share this questionnaire button 786 can cause an interface page to be generated that allows the recruiter to post the questionnaire to a social media site. A selection of the post to my circles button 788 causes an interface to be generated that allows the recruiter to post the questionnaire to their circles, such as circles on which they have administrative privileges. A list questions 790 associated with the questionnaire is posted at the end. The type of question (e.g., video or text), a description of the question and points are listed for each question. A recruiter can select a question to modify it.

A selection of the responses tab can provide details about the responses, such as names of the individuals that have responded. A selection of the individuals that are listed can cause the system to display their responses to the questionnaire. A selection of the reports tab 762 can cause an interface to be generated that allows a recruiter to review reports on the questionnaire as described above with respect to FIG. 15. A selection of the reviewers tab 764 can cause the system to display a page that allows a recruiter to assign reviewers to responses and view whether a review has performed or not.

FIG. 17 is a screen shot 800 of a welcome page for a video interview including a questionnaire in a PTN. A bar at the top indicates a status of the questionnaire. The questionnaire is divided into five phases: 1) an introduction 802, 2) check webcam, 3) practice question, 4) take questionnaire and 5) done. In FIG. 17, the questionnaire is in the introduction state. The welcome page includes a name of the recipient 812, a welcome video 814 which can be viewed by the participant, a name 816 of the PTN staff member that created the questionnaire, a description and rules 818 of the questionnaire and an indication 820 that the questionnaire is to be recorded. A selection of the check webcam button 822 can cause the questionnaire to advance to the next step which is a check of the remote interface.

FIG. 18A is a screen shot 830 of questionnaire page in a state for checking a participant's interface. The status of the page indicates it is in the check webcam state 804. The check webcam section 832 shows a current video image of the participant. In 836, the participant is given an option to select the webcam hardware or not to show the video. The check microphone section 834 shows a sound level being recorded by the system. In 834, the user is given the option of selecting their microphone hardware or not using a microphone. A selection of the practice question button 840 causes the system to advance to the next state where a user can take a practice question as described as follows.

FIG. 18B is a screen shot 850 of questionnaire page in a state for taking a practice question. The status of the page indicates it is in the practice question state. In section 852, a practice question is “what do you do in your free time.” The interface indicates the type of question 854. In this example, the question is a video answer that is to be recorded. The system can generate a countdown at which point the system will start recording the video answer. A time remaining 856 to answer the question can be displayed. In this example, a portion of a circle is shown to indicate the time remaining. The total amount of time for the question is one minute.

When the participant is ready, the participant can select the start questionnaire button 858. After the selection, the questionnaire can display each question to a page in a format similar to the practice question page. After each of the questions is displayed, the system can display a “done” page with a closing message. As described above, the participant can be invited to log into the PTN with a social media account. After completion, the response results can be made available on the pages of individual that created the questionnaire and individuals that have access to the questionnaire. Overall stats associated with the questionnaire can be updated. In addition, reviewers for the response can be assigned.

Next, a method of video interviewing in a PTN is described. With Live screening/interviewing, a recruiter or other staff member within the PTN can interact live with individuals as well as a small group of people. Candidates who already belong to your network or new candidates can be invited. During the interview, recruiters can further their knowledge of candidates as well as possibly evaluate their actual leadership qualities (if the candidates are invited to participate in group meeting). The video interviewing environment is configured to allow checks of the candidates' profiles in real time and share relevant supporting documents or a job description. For larger groups, webinars are also available. In a webinar, the participants video capabilities may be limited.

FIG. 19 is a flow chart of a method 900 of generating interviews in a PTN. In 902, a meeting schedule interface can be generated. The meeting schedule interface allows a video meeting to be scheduled. Details of the meeting configuration interface are described above with respect to FIG. 6 and step 316. As described above, members and non-members of the PTN can be invited to a meeting.

In 904, after a meeting is scheduled various calendars within the PTN can be updated. Meetings which are scheduled by a staff member and public meetings scheduled by others on a team can be maintained in the PTN calendar. Color codes can be used to indicate the type of the meeting, such as open to RSVP's, invite only and one on one. In 906, the PTN calendar can be synched with a staff member's desktop calendar to allow the meeting to appear on the staff member's dashboard. In addition, in 906, when a candidate is invited, the meeting can also be visible on the candidate's personal dashboard in the PTN.

In 908, a video meeting can be initiated. To start a meeting, a user with the appropriate privileges can click on the link of the meeting or the item in the calendar. Prior to beginning the meeting, the system can request whether the organizer wants to record the meeting. During the meeting, the recording can be paused. Further, if the organizer initially elects to not record the meeting, the organizer can initiate recording during a video session. Then, like the questionnaire described above, via the interface, the organizer can check whether their webcam and microphone are working properly. Other meeting participants are also provided this option. The user and the candidate have the option of disabling their video feed during the video meeting. Thus, only voice communications will be recorded when an individual selects this option.

In 910, a video interface is generated for the meeting participants. A recruiter's interface can be different than a candidates interface. Via the recruiter's interface, the recruiter can see a candidate's profile that is participating by selecting the candidate's name. In addition, the recruiter can search for other candidate's profiles, such as for the profile of a candidate that is not participating for comparison purposes. Via interface, a recruiter can upload a document that is displayed during the meeting. The recruiter can control a portion of the document that is displayed by browsing through the document. In one embodiment, only the recruiter has this control.

The interface can include an area where the recruiter (organizer) can take notes. The notes are not visible to other participants, such as candidates seeking a job. The notes can be saved with a recording of the meeting and later viewed by the recruiter, team members with sufficient privileges or hiring managers. A recruiter can post a job description that is visible to the participants. When the candidate has their video on, the recruiter can gage their reaction to the job description, such as to assess their interest in the job.

Another feature of the video interface is a text-chat function. Yet another feature is an ability to send files for download. For example, the candidate can receive the document and then download it to their computer. Again, only the recruiter may be allowed this privilege.

In 912, the video and text chat portions of the meeting can be saved. In 914, the meeting can be shared with others, such as hiring managers, and the meeting can be replayed. The PTN provides a search feature where a recruiter can search on such factors as meeting participants, job discussed, locations and tags added to the meeting.

Once a recorded meeting is selected, the recruiter can replay the meeting and view the chat transcript. Further, the interface provides a mechanism for allowing a recruiter to add additional remarks that can be saved and viewed by others. Then, via the interface, the recruiter can select one or more PTN members to view the recording and invite them to add additional comments. The interface can include a message component that allows the recruiter to add a message when the recording is shared with other users.

Next, two examples of a video interface are described with respect to FIGS. 20 and 21. FIG. 20 is a screen shot of a video interface during an interview between a recruiter and a single candidate (meeting participant). The title 938 of the meeting is human-computer interaction discussion. A selection of the video chat tab 932 can bring the video feeds of the meeting participants forward. A selection of the document tab 934 can cause a box 940 including the document forward. A selection of the change document button 942 can cause an interface state to be generated where the recruiter to change the document that is displayed. Again, only a meeting organizer (recruiter) may be able to access these features.

A selection of the pause button 944 by the recruiter can cause the recording of the meeting components to be stopped. A selection of the organizer menu button 946 causes the interface to display additional organizer features. In the chat section 948, the recruiter can text chat with the candidate. The text chats that occur can be recorded and shown back in order during replay.

A selection of the attach doc button 945 can allow the recruiter to attach a document. When the send is selected, the document can be sent to the candidate. The members section 954 includes the meeting participants. The candidate is Yuriy and the recruiter organizing the meeting is Karen. A selection on Yuriy name can cause the interface to generate a pop up box with Yuri's profile 950. As described above, the recruiter can add comments during the meeting that are saved with the recording of the meeting. The comments can be entered in the comments section.

FIG. 21 is a screen shot 960 of a video interface during an interview between a recruiter and multiple candidates 962. The video interface can be generated for a meeting organizer. A candidate interface would not include features, such as the ability to close, pause or take notes in the video meeting.

The PTN allows recruiters to schedule interactive group discussions involving members who either already belong to a circle or are still outside of the PTN. Candidates (up to some maximum, such as 10) can interact via video and also send text remarks. During the group meeting, the recruiter can take private notes on what he/she sees. As the conversation unfolds, the recruiter can check each candidate's professional profile, seeing the candidate's work history, education, skills, and other professional information. Via the interface, during the conversation, participants can view and discuss documents together. As previously described, the entire conversation can be recorded and sent to a hiring manager for feedback.

For larger groups, a webinar can be used. The video images of the speakers can be presented and documents can be viewed under control of the speaker. However, the audience may only be allowed to participate via text chats. In one embodiment, the audience members may be allowed to attach documents that can be viewed during the meetings. In other embodiments, only the speaker may have access to this feature.

Embodiments of the present invention further relate to computer readable media that include executable program instructions for performing recruiting techniques described herein. The media and program instructions may be those specially designed and constructed for the purposes of the present invention, or any kind well known and available to those having skill in the computer software arts. When executed by a processor, these program instructions are suitable to implement any of the methods and techniques, and components thereof, described above. Examples of computer-readable media include, but are not limited to, magnetic media such as hard disks, semiconductor memory, optical media such as CD-ROM disks; magneto-optical media such as optical disks; and hardware devices that are specially configured to store program instructions, such as read-only memory devices (ROM), flash memory devices, EEPROMs, EPROMs, etc. and random access memory (RAM). Examples of program instructions include both machine code, such as produced by a compiler, and files containing higher-level code that may be executed by the computer using an interpreter.

The foregoing description, for purposes of explanation, used specific nomenclature to provide a thorough understanding of the invention. However, it will be apparent to one skilled in the art that the specific details are not required in order to practice the invention. Thus, the foregoing descriptions of specific embodiments of the present invention are presented for purposes of illustration and description. They are not intended to be exhaustive or to limit the invention to the precise forms disclosed. It will be apparent to one of ordinary skill in the art that many modifications and variations are possible in view of the above teachings.

While the embodiments have been described in terms of several particular embodiments, there are alterations, permutations, and equivalents, which fall within the scope of these general concepts. It should also be noted that there are many alternative ways of implementing the methods and apparatuses of the present embodiments. It is therefore intended that the following appended claims be interpreted as including all such alterations, permutations, and equivalents as fall within the true spirit and scope of the described embodiments.

What is claimed is:

1. A system including at least one processor and a memory, the system comprising:
a database residing in the memory, said database storing member profiles for a plurality of members of a private talent network (PTN) for only a single company wherein a first portion of the members are job recruiters for the single company and a second portion of the members are job candidates for job positions available at the single company;
a processor configured to 1) log in a job candidate into the private talent network and generate a candidate interface for the job candidate within the PTN wherein the candidate interface allows the job candidate to access features of the PTN available to job candidates, 2) log in a job recruiter into the PTN and generate a recruiter interface within the PTN for the job recruiter wherein the recruiter interface allows the job recruiter to access features of the PTN available to the job recruiters, 3) receive via the recruiter interface a request to create a video meeting wherein within the PTN only the recruiters are allowed to create video meetings; 4) generate a meeting creation interface within the recruiter interface for the job recruiter; 5) based upon inputs received via the meeting creation interface from the job recruiter, create the video meeting; 6) receive requests to join the meetings from the job recruiter via the job recruiter interface and the job candidate via job candidate interface; 7) generate a job recruiter video meeting interface integrated into the PTN for the job recruiter and a job candidate video meeting interface integrated into the PTN for the job candidate to enable video communications between the job candidate and the job recruiter; 8) during the video meeting, output simultaneously within both the job recruiter video meeting interface and the job candidate video meeting interface live video images of the job recruiter and the job candidate and live images of a portion of a document, 9) receive, via only the job recruiter interface, commands to change the portion of the document that is output and in response to the commands, output a different portion of the document within the job recruiter video interface and the job candidate video interface, 10) output within the job recruiter video interface a selectable link to a member profile for the job candidate wherein a selection of the link causes a member profile for the job candidate to be simultaneously output with the live video images of the job recruiter, the job candidate and the document within the job recruiter interface while only the live images of the job recruiter, the job candidate and the document are output to the job candidate interface.

2. The system of claim 1, wherein the meeting creation interface is configured to receive an input of identification information for one or more members of the PTN to invite to the video meeting.

3. The system of claim 1, wherein the meeting creation interface is configured to receive an input of contact information for one or more non-members of the PTN to invite to the video meeting.

4. The system of claim 3, wherein, when the video meeting is created and a non-member of the PTN is invited, the processor is further configured to send, using the contact information, an invitation message including information about the video meeting and a link to a registration interface for joining the PTN and wherein the non-member is required to join the PTN and then log into the PTN before participating in the video meeting.

5. The system of claim 1, wherein the meeting creation interface is configured to receive input of a job description for job position at the single company associated with the video meeting wherein the job description is included with an invitation to the video meeting.

6. The system of claim 1, wherein, after the video meeting is created in the meeting creation interface, the processor is further configured to output meeting information including a meeting schedule and a meeting description in the job candidate interface and the job recruiter interface.

7. The system of claim 1, wherein the meeting creation interface is configured to output a list of circles within the PTN wherein each circle includes one or more of the members of the PTN and wherein a selection of each circle on the list causes meeting information associated with the video meeting to be made available to members of each selected circle.

8. The system of claim 1, wherein the meeting creation interface is configured to receive a designation of a maximum number of video meeting attendees for the video meeting and receive a designation of a number of video meeting invitees to the video meeting greater than the maximum number of video meeting attendees.

9. The system of claim 1, wherein the meeting creation interface is configured to receive a designation indicating the video meeting is a webinar and wherein during the webinar, live video images of only one meeting participant are output.

10. The system of claim 1, wherein the meeting creation interface is configured to receive a designation that the video meeting is only open to PTN members specifically invited.

11. The system of claim 1, wherein the meeting creation interface is configured to receive a designation that the video meeting is open to any PTN members that RSVP to a notice of the video meeting posted to one or more calendars visible within the PTN.

12. The system of claim 1, wherein meeting creation interface is configured to upload the document which is output during the video meeting via job candidate video interface and the job recruiter video interface.

13. The system of claim 1, wherein the job recruiter video interface includes a section for receiving an input of text notes during the video meeting that only visible in the job recruiter video interface.

14. The system of claim 13, wherein the processor is further configured to store a copy of the text notes input linked to a stored recording of the video meeting.

15. The system of claim 1, wherein job recruiter video interface includes controls for initiating or stopping a recording of the video meeting.

16. The system of claim 1, wherein at a beginning of the video meeting, the processor is configured to generate a feature within the job recruiter interface and the job candidate interface that allows the job recruiter and the job candidate to test whether video and/or sound is being properly transmitted via the each of the interfaces.

17. The system of claim 1, wherein the job recruiter video interface includes a selectable link which upon selection causes a job description to be output in the job recruiter interface and the job candidate interface, said link only available in the job recruiter interface.

18. The system of claim 1, wherein the job recruiter video interface is configured to allow a first document to be uploaded and sent to the job candidate.

19. The system of claim 1, wherein the job recruiter video interface and the job candidate video interface each includes a link for initiating a text chat between the recruiter and the candidate such that text entered via the job recruiter video interface is visible on the job candidate video interface and the text entered via the job candidate video interface is visible on the job recruiter video interface.

20. The system of claim 19, wherein the processor is further configured to store the text entered via the job recruiter video interface or the job candidate video interface with a recording of the video meeting such that the recording of the video meeting and the text can be replayed in sync with one another.

21. The system of claim 1, wherein the job recruiter interface is configured to receive search terms that allows a stored recording of the video meeting to be located and replayed.

22. The system of claim 21, wherein the job recruiter interface is configured to receive additional notes during a playback of the recording of the video meeting and store the additional notes with the recording of the video meeting.

23. The system of claim 21, wherein the job recruiter interface is configured to generate a message including a request for another PTN member to view the recording of the video meeting and a link to the recording within the PTN.
